(19) United States
(12) Patent Application Publication
(10) Pub. No.: US 2016/0299623 A1
(43) Pub. Date: Oct. 13, 2016

(54) TEXT INPUT METHOD

(71) Applicants: AMBIT MICROSYSTEMS (SHANGHAI) LTD, Shanghai (CN); HON HAI PRECISION INDUSTRY CO., LTD., New Taipei (TW)

(72) Inventors: CHI-CHANG LU, New Taipei (TW); Chih-Yao Lee, New Taipei (TW)

(21) Appl. No.: 15/186,553

(22) Filed: Jun. 20, 2016

Related U.S. Application Data
(63) Continuation-in-part of application No. 14/941,678, filed on Nov. 16, 2015, now Pat. No. 9,395,839.
Application No. 14/941,678 is a continuation of application No. 13/866,029, filed on Apr. 19, 2013, now Pat. No. 9,218,077.

(30) Foreign Application Priority Data
Apr. 20, 2012 (TW) 101114061

(51) Int. Cl. G06F 3/041; G06F 3/0486; G06F 3/0482

(52) U.S. Cl. CPC G06F 3/0416; G06F 3/0414; G06F 3/0482; G06F 3/0486

(57) ABSTRACT

A text input method executable by an electronic device comprises input of phonemes and rendering each phoneme gesture operable. A list of word candidates is derived from the phonemes. The phonemes are modified in response to a gesture on at least one of the phonemes. A update list of word candidates are derived from the modified phonemes.

### CROSS-REFERENCE TO RELATED APPLICATIONS

This application is a continuation in part of U.S. application Ser. No. 14/941678, entitled “TOUCH CONTROL METHOD AND ELECTRONIC SYSTEM UTILIZING THE SAME,” filed on Nov. 16, 2015, published as US 20160070400 A1, which is a continuation of U.S. application Ser. No. 13/866029, entitled “TOUCH CONTROL METHOD AND ELECTRONIC SYSTEM UTILIZING THE SAME,” filed on Apr. 19, 2013, published as US 20130278520 A1, which is based upon and claims the benefit of priority from Taiwan Patent Application No. 101114061, filed on Apr. 20, 2012. The entirety of each of the above-mentioned patent applications is hereby incorporated by reference herein.

### BACKGROUND

1. Technical Field

Embodiments of the present disclosure relate to a computer technologies, and more particularly to a text input method and an electronic system utilizing the same.

2. Description of Related Art

Smart mobile phones and tablet computers have become increasingly popular. These kinds of mobile devices are typically equipped with a touch device rather than a mouse. Some mouse operations, such as selecting and dragging of icon and/or text, however, are not easy to be replaced by touch operations. Since moving operations, such as swiping or sliding, on capacitive or infrared touch device are typically defined to move screens or menus, a tap or a touch operation that initiates a moving touch operation is usually interpreted as the beginning of a swiping or a sliding action rather than selection of an object that initiates dragging of the object. When a drag operation is utilized to select a group of text, for example, a press down operation is required to select a first part or a first word of the text, then held to select a last word, and the action is released to complete the selection of the text. Alternatively, when a drag operation is utilized to move an icon, a press down operation is required to select the icon, then held and moved to a destination of the icon, and released to complete the move of the icon.

A time threshold is typically required to distinguish between a swipe and a drag operation. A press operation on an object with an operation time greater than the time threshold is referred to as a long press and interpreted as a selection of the object that initiates dragging of the object. A press operation on an object when terminated on the object with a shorter operation time is referred to as a short press and interpreted as a selection of the object that initiates execution of an application represented by the object. A press operation on an object when held and moved to leave the object with an operation time less than the time threshold is interpreted as a beginning of a swipe operation that moves a screen of a smart mobile phone rather than the object.

In some applications, the time threshold utilized to distinguish between a swipe and a drag complicates user operations and affects application fluency. For example, selecting an object in a computer game according to the time threshold may cause loss of opportunities in the game.

Additionally, a cell phone is not very convenient for text input since it typically has limited size for a keyboard. Some keyboard has multifunctional keys each representing a number and a letter. As a cell phones are installed with more and more different keyboards of different languages, symbols, and emojies, and different input methods, switching between the keyboards can be troublesome and time consuming.

### BRIEF DESCRIPTION OF THE DRAWINGS

FIG. 1A is a block diagram of one embodiment of an electronic system in accordance with the present disclosure;

FIG. 1B is a schematic diagram of one embodiment of a remote control application;

FIGS. 2A-2G are schematic diagram showing curves of pressure, curves of pressed area, and curves of net forces associated with touch operations;

FIG. 3 is a schematic diagram showing software and hardware layers of a mobile device and a media player device;

FIG. 4 is a flowchart showing a process of determination as to whether a selection or a dragging operation is initiated by touch operation signals;

FIG. 5A is a block diagram of an embodiment of an electronic device;

FIG. 5B is a schematic diagram of an exemplary embodiment of a keyboard;

FIG. 6A is schematic diagram showing a framework indicating effectiveness of a heavy press.

FIG. 6B is a schematic diagram showing operation signals with reference to a time line;

FIG. 7 is flowchart showing another embodiment of a character input method which utilizes a menu to display characters;

FIG. 8A is a schematic diagram showing a menu corresponding to a default sequence of character candidates “wxyz”;

FIG. 8B is a schematic diagram of a text area in which a character “x” in the default sequence “wxyz” is displayed;

FIG. 8C is a schematic diagram of a text area into which a character “y” is entered;

FIG. 8D is a schematic diagram showing another embodiment of a menu in which character candidates are represented by assistant keys;

FIG. 9 is a schematic diagram showing an embodiment of a first input mode menu in which options of input methods are represented by assistant keys and associated with keyboards;

FIG. 10 is a schematic diagram showing an embodiment of a second input mode menu in which alternative options of input methods are represented by assistant keys and associated with keyboards;

FIG. 11 is a schematic diagram of another embodiment of a keyboard;

FIG. 12A is a schematic view of a template of a key associated with key options arranged in a default sequence;

FIG. 12B is a schematic view of a template of the key associated with key options arranged in an alternative sequence;

FIG. 13 is a flowchart of an exemplary embodiment of a text input method for phonemes processing;

FIG. 14 is a schematic view of a delete gesture associated with a phoneme;

FIG. 15 is a schematic view of a phoneme area with a phoneme removed by a delete gesture;

FIG. 16 is a flowchart of an exemplary embodiment of heuristics for determining delete, copy, move, and replace gestures;

FIG. 17 is a schematic view of a copy gesture associated with a phoneme;

FIG. 18 is a schematic view of a move gesture associated with a phoneme;

FIG. 19 is a schematic view of a replace gesture associated with a phoneme; and

FIG. 20 is a schematic view of an alternative phoneme replacing an original phoneme in response to a replace gesture; and

FIG. 21 is a schematic view of a finite state machine associated with a graphical user interface (GUI) element.

### DETAILED DESCRIPTION

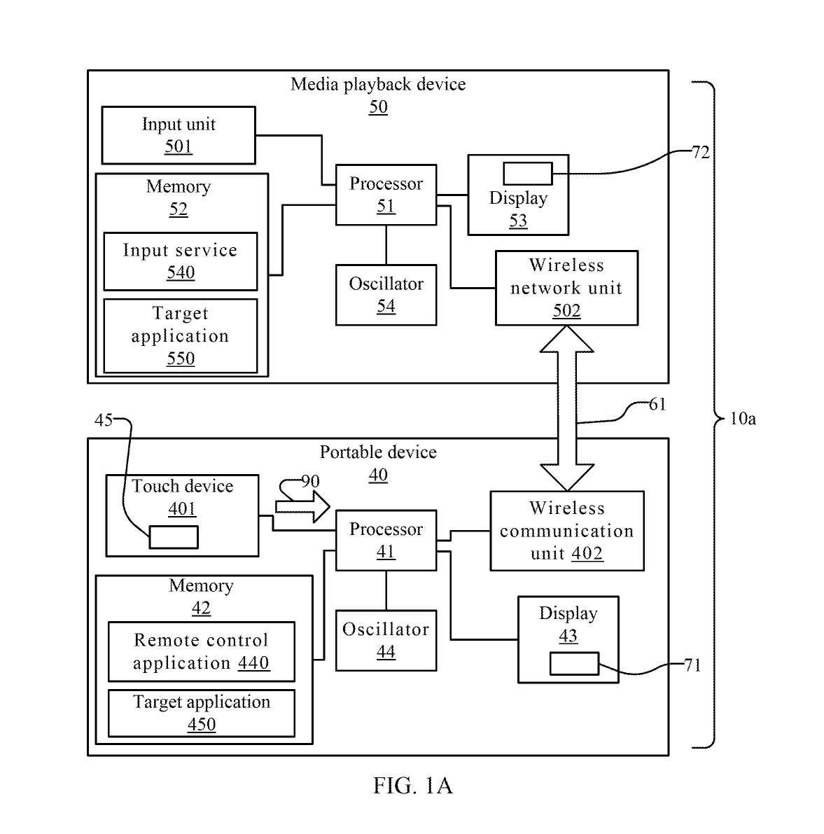

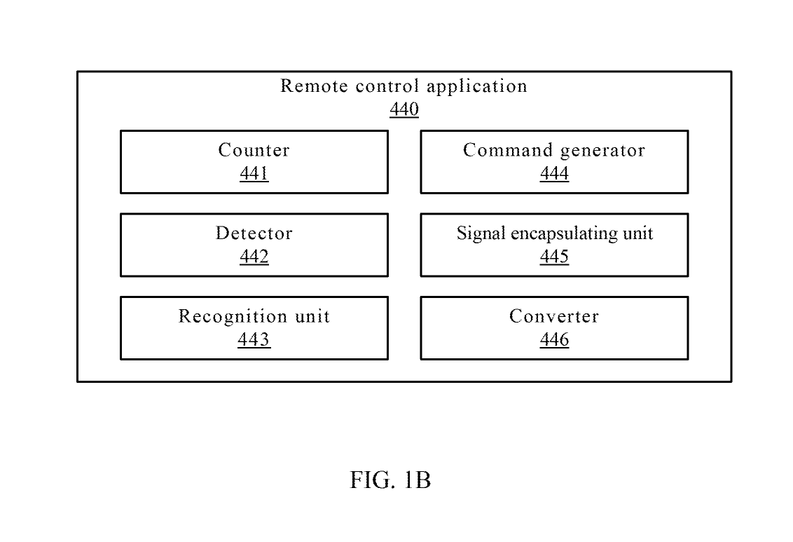

The disclosure is illustrated by way of example and not by way of limitation in FIGS. 1-5 of the accompanying drawings in which like references indicate similar elements. Various embodiments illustrate different features of the disclosure. It should be noted that references to “an” or “one” embodiment in this disclosure are not necessarily to the same embodiment, and such references can mean “at least one.” Descriptions of components in the embodiments are given for the purpose of illustrating rather than limiting.

Embodiments of a touch control method and an electronic system utilizing the same are given as follows, thus providing user friendly and intuitive controls to electronic systems such as smart mobile phones, tablet personal computers, set-top boxes, and smart televisions. The embodiments of this touch control method and an electronic system utilize a short press to simulate a long press.

### 1. System Overview

With reference to FIG. 1A, an electronic system 10a comprises mobile device 40 and media player device 50. Units and modules in the electronic system 10a may be realized by computer programs or electronic circuits. A processor 41 in the mobile device 40 is in communication with a memory 42, a display 43, a touch device 401, and a wireless communication unit 402. Embodiments of the mobile device 40 may comprise personal digital assistants (PDAs), laptop computers, smart mobile phones or tablet personal computers. The memory 42 in the mobile device 40 may comprise an operating system and applications, such as ANDROID™ operating system and a remote control application 440 and a target application 450.

FIG. 1B shows a schematic view of the remote control application 440. A detector 442 detects touch operations of the touch device 401. A touch operation comprises a user operation on a touch sensitive device such as the touch device 401 and the event is detected by the touch sensitive device. Various gestures applied to the touch sensitive device are detected by the touch sensitive device as different touch operations such as press-down, release, short press, long press, light press, heavy press, drag, move, swipe, and other operations/events. A short press on the touch device 401 with a net force greater than a net force threshold is referred to as a heavy press. A command generator 444 generates the consequences of a long press signal upon receiving a short press on the touch device 401 with a net force greater than a net force threshold. A signal encapsulating unit 445 encapsulates signals generated by the command generator 444 in a unit of data, such as a frame of a packet. The command generator 444 generates and transmits wireless touch signals of touch operation signals 90 associated with the touch device 401 through the signal encapsulating unit 445 and the wireless communication unit 402 to the media player device 50, to exert overall control of the media player device 50. The wireless touch signals represent net force measurements representative of touch operation signals 90 associated with the touch device 401. The remaining units and module in the remote control application 440 are detailed as follows.

A processor 51 in the media player device 50 is in communication with a memory 52, a display 53, an input device 501, and a wireless communication unit 502. Embodiments of the media player device 50 may comprise smart televisions or set-top boxes. FIG. 1 is provided for an example. An embodiment of the media player device 50 which comprises a set-top box may not comprise the display 43. Embodiments of the mobile device 40 may also comprise a media player device, such as a smart television.

The memory 52 in the media player device 50 may comprise an operating system and applications, such as Android™ operating system, an input service application 540 and a target application 550.

The processors 41 and 51 respectively constitute a central processing unit of the mobile device 40 and of the media player device 50, operable to process data and execute computer programs, and may be packaged as an integrated circuit (IC).

The wireless communication units 402 and 502 establish wireless communication channels 61 to facilitate wireless communication between the mobile device 40 and the media player device 50 through the wireless communication channels 61, connection to an application store on the Internet, and downloading of applications, such as the remote control application 440 and the input service application 540, from the application store.

Each of the wireless communication units 402 and 502 may comprise antennas, base band and radio frequency (RF) chipsets for wireless local area network communications and/or cellular communications such as wideband code division multiple access (W-CDMA) and high speed downlink packet access (HSDPA).

Embodiments of the touch device may comprises capacitive, resistive, or infrared touch devices. The touch device detects touch operations and generates electrical touch operation signals based on the touch operations, and generates digital touch operation signals based on the electrical touch operation signals. The digital touch operation signals comprise a sequence of touch operation packets representative of the touch operations. Each packet within the touch operation packets comprises a pressure field, area field, and coordinate field respectively operable to store a pressure value, a pressed area, and coordinates representing a touch operation represented by the packet.

The touch device 401 may comprises a touch panel overlaid on a display, and may be integrated with the display 43 to be a touch display. The input device 501 may comprises functional control keys, alphanumeric keyboards, touch panels, and touch displays.

In the remote control application 440, the detector 442 detects user operations on the touch device 401. A counter 441 counts and signifies to the processor 41 an initiating time, a termination time, and duration of each of various user operations on the touch device 401. A selection recognition unit 443 determines whether a press on the touch device 401 is a heavy press to represent a long press. A long press comprises a press with an operation period greater than a time duration threshold, and a short press is a press with an operation period less than the time duration threshold. A heavy press is a press on the touch device 401 with a net force greater than a net force threshold. A value of net force of a touch operation on the touch device 401 is the product of a pressure value and a pressed area associated with the touch operation with respect to a point in time. The heavy press is recognized based on the net force threshold rather than on the time threshold, so a heavy press may be a short press.

A oscillator 44 provides clock signals to the processor 41 and other components in the mobile device 40. A oscillator 54 provides clock signals to the processor 51 and other components in the media player device 50. A controller 45 and/or a driver of the touch device 401 generates data packets of touch operations with respect to time with reference to clock signals provided by the oscillator 44 or the counter 441. Each packet within the touch operation data packets comprises a pressure value, a pressed area, and coordinates of a touch operation on the touch device 401 represented by the packet respectively stored in a pressure field, an area field, and a coordinate field of the packet.

The signal encapsulating unit 445 inputs as many touch operation packets of the sequence of touch operation packets as the duration of a certain time interval allows to a converter 446. The converter 446 generates a net force value of each input packet selected from these touch operation packets via the calculation of the product of a pressure value and a pressed area of the input packet, and thus generates net force values of the touch operation packets as a net force measurement of the touch operations, which may be rendered as a net force curve on a coordinates system.

In alternative embodiments, the converter 446 multiplies a pressure value and a pressed area associated with each input touch operation packet to obtain a product value for each input touch operation packet, and averages product values of a plurality of input touch operation packets over a specific period of time to obtain an averaged product value as a net force value of the input touch operation packet.

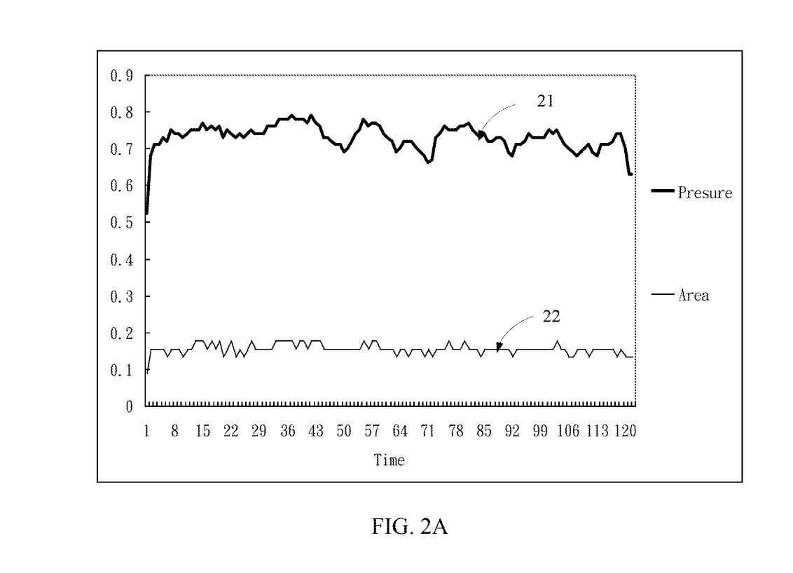

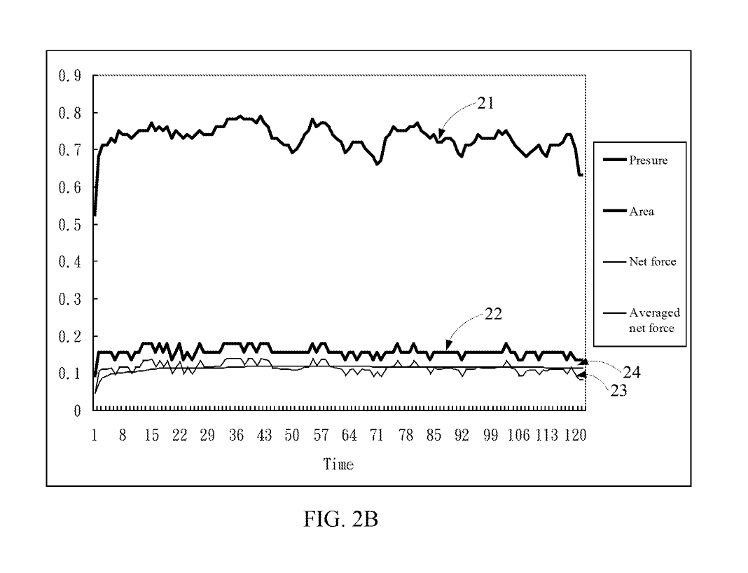

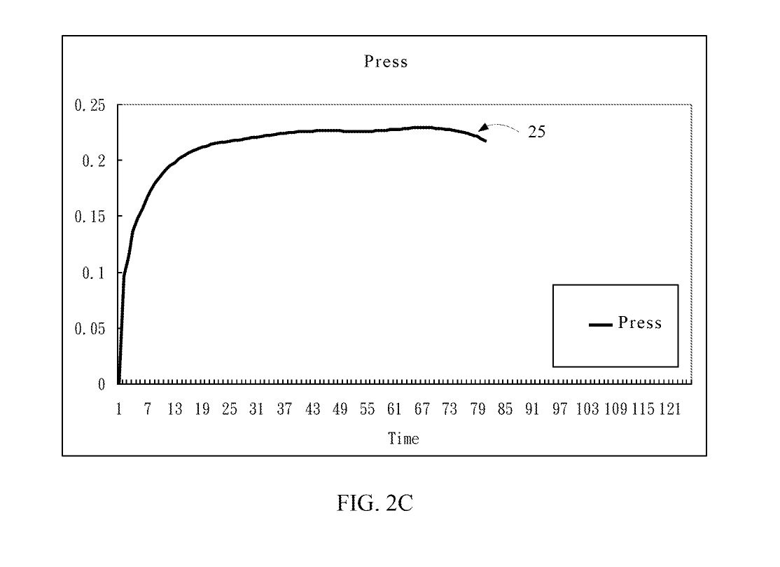

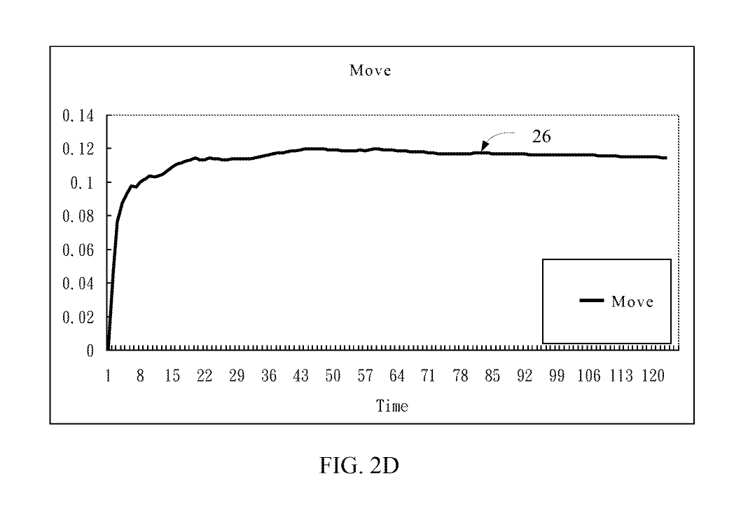

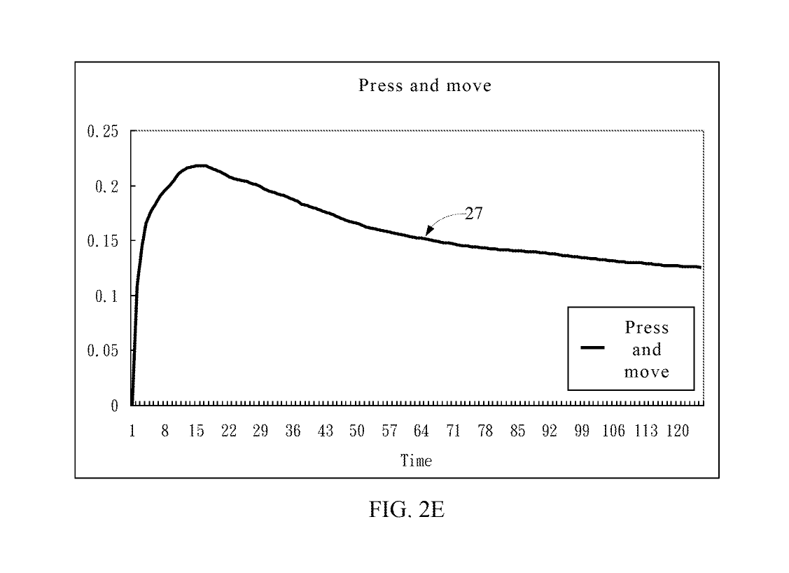

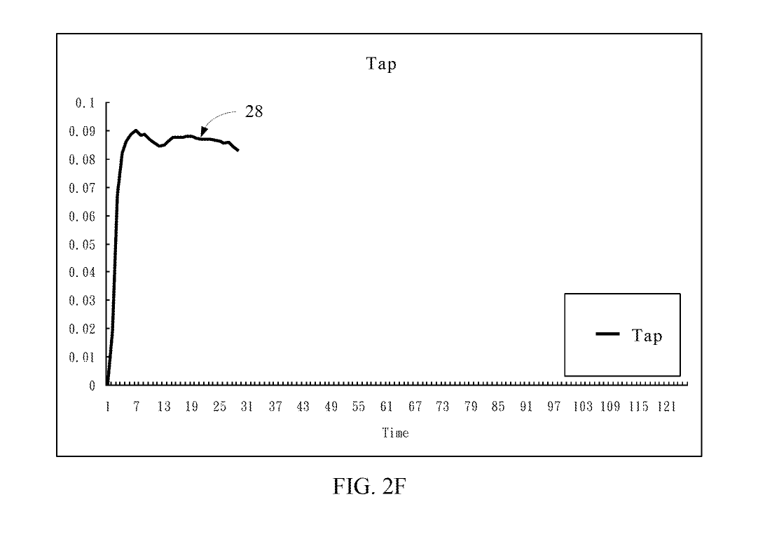

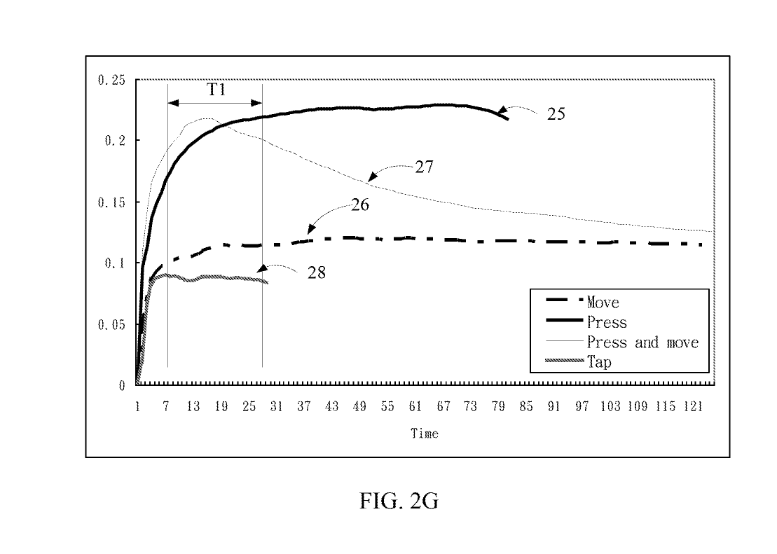

The signal encapsulating unit 445 or the converter 446 stores the net force of the input touch operation packet in the pressure field of the input touch operation packet to replace a pressure value in the pressure field. With reference to FIG. 2G, the specific period of time is illustrated as a time interval T1, and may be defined as a time interval smaller than T1, such as segment of time interval T1.

The processor 41 displays an object 71 on the display 43. The mobile device 40 comprises a target program which requires a long press to initiate selection of the object 71 and terminates the selection upon receiving a release event associated with the object 71. The target program of the mobile device 40 continues to receive coordinates of touch operations represented by touch operation signals 90 and may realize the commencement of a drag operation of the object 71 according to the received coordinates. Examples of the target program may comprises a target application 450 or an operating system. The target application 450 of the mobile device 40, for example, requires a long press to initiate selection of the object 71. The long press comprises a press with an operation period greater than a time duration threshold, and the mobile device 40 counts the period of operation from the onset of the long press to release or termination of the long press.

The processor 51 displays an object 72 on the display 53. The media player device 50 comprises a target program which requires a long press to initiate selection of the object 72 and terminates the selection upon receiving a release event associated with the object 72. The target program of the media player device 50 continues to receive coordinates of touch operations represented by touch operation signals 90 and may realize a drag operation of the object 72 according to the received coordinates.

Examples of the target program may be a target application 550 or an operating system. The target application 550 of the media player device 50, for example, requires a long press to initiate selection of the object 72. The long press is a press with an operation period greater than a time duration threshold, and the media player device 50 counts the period of operation from the onset of the long press to release or termination of the long press.

### 2. Signals of Various Gestures Detected by a Force Sensitive Device

FIG. 2A shows a curve of pressure 21 and a curve of pressed area 22 associated with the touch operation signals 90 received by the processor 41 from touch device 401. The touch operation signals 90 comprises a sequence of touch operation packets. The sequence of touch operation packets comprises a plurality of touch operation packets. A horizontal axis in FIGS. 2A-2G represents sequence numbers of packets receive by the processor 41 with respect to time, and a vertical axis in FIGS. 2A-2G represents values in the pressure fields and area field of the received packets. The curve of pressure 21 is obtained from pressure values of the touch operation packets stored in the pressure fields of the touch operation packets. The curve of pressed area 22 is obtained from pressed area of the touch operation packets stored in the area fields of the touch operation packets.

FIG. 2B shows curves of net force 23 and 24 associated with the touch operation signals 90 received by the processor 41 from touch device 401. The curves of net force 23 and 24 are obtained from net force values of the touch operation packets stored in the pressure field. The curve of net force 23 is obtained from a multiplication calculation. The curve of net force 24 is obtained from the multiplication and the averaging calculation.

FIGS. 2C, 2D, 2E, and 2F respectively show curves of net force 25, 26, 27, and 28 associated with the touch operation signals 90 received by the processor 41 from touch device 401. The curves of net force 25, 26, 27, and 28 represent different touch operations on the touch device 401. The curve of net force 25 represents a press down operation/event. The curve of net force 26 represents a touch movement operation/event. The curve of net force 27 represents a press and move operation/event. The press and move operation/event comprises a drag operation wherein a touch movement operation/event follows a press down operation/event. The curve of net force 28 represents a light press operation/event. A light press comprise a press operation with a net force less than a net force threshold. A heavy press comprise a press operation with a net force equal to or greater than a net force threshold.

FIG. 2G show a combined view of curves of net force 25, 26, 27, and 28 for convenience of comparison. A discernible difference exists between curves 25 and 27 representing at least a press down operation/event and curves 26 and 28 representing at least a light press operation/event. The selection recognition unit 443 may determine that curves 25 and 27 both represent a heavy press and that curves 26 and 28 do not represent a heavy press based on a net force threshold. The selection recognition unit 443 may interpret a portion of the curves 25 and 27 within time period T1 as being touch signals representing a heavy press which may be utilized to trigger selection of the object 71 or 72.

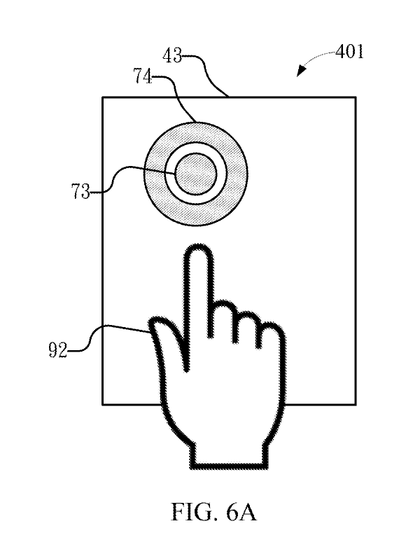

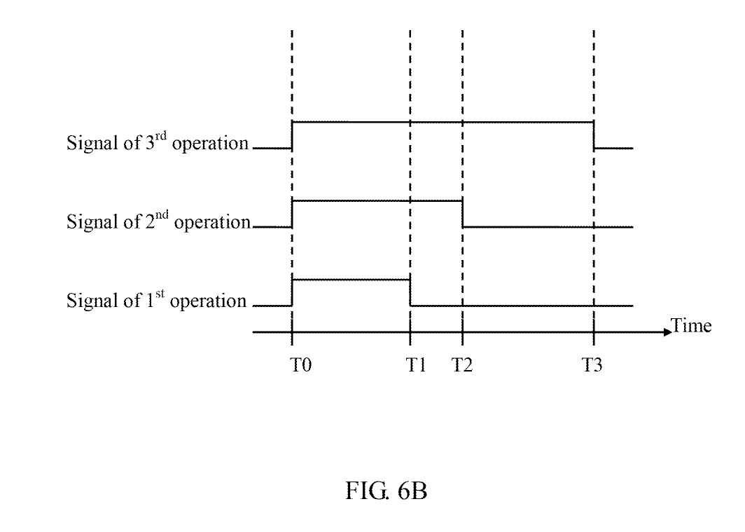

As shown in FIG. 6A, if a heavy press is applied to an object 73 by a user 92, a framework 74 may be displayed to enclose the object 73 upon selection of the object 73, thus indicating the selection of the object 73, referred to as a first selection operation, during a period of first selection operation. The electronic system 10a may utilize various visual effects to indicate a heavy press on the object 73. Examples of the object 73 are the object 71 or 72.

The left end of each curve near the origin represents an onset point of a touch operation represented by the curve. An interval between the left end of each curve to the right limit of the time period T1 is smaller than the time threshold. In FIG. 2G, for example, time intervals between the origin to the left limit of the time period T1 and between the origin to the right limit of the time period T1 are substantially 0.1 seconds and 0.5 seconds respectively.

### 3. Transmission of Force Representative Gesture Signals

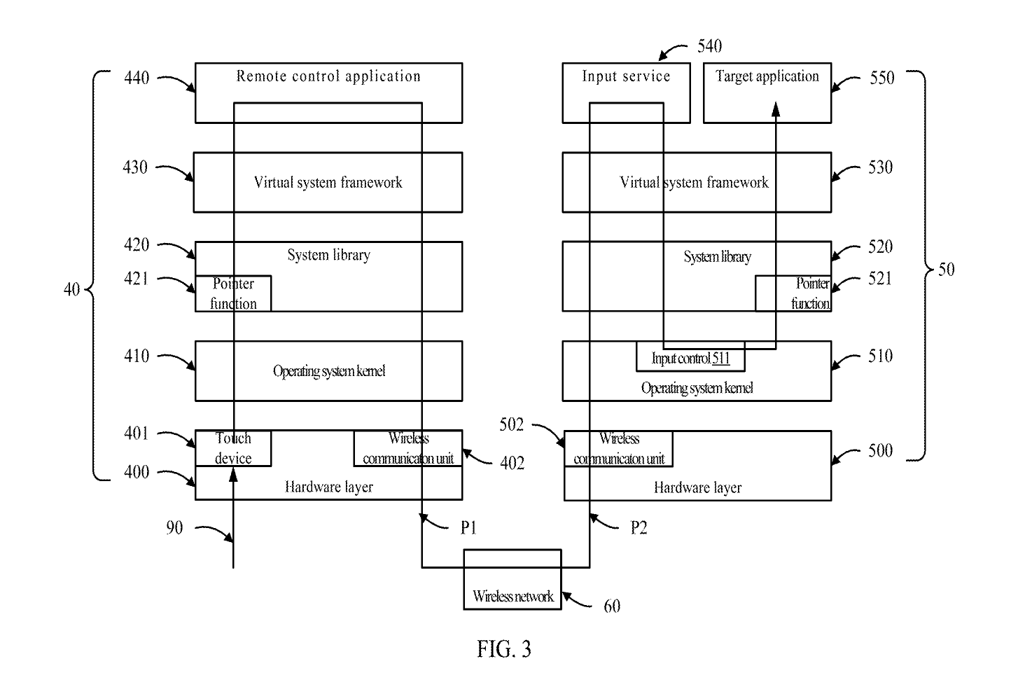

With reference to FIG. 3, the mobile device 40 receives touch operation signals 90 via the touch device 401 of the hardware layer 400. The processor 41 of the mobile device 40 delivers and converts the touch operation signals 90 between the software and hardware units of the mobile device 40 in the sequence indicated by a path P1. The mobile device 40 then utilizes the wireless communication unit 402 of the hardware layer 400 to transmit the touch operation signals 90 to the media player device 50 through the wireless network 60.

The media player device 50 receives the touch operation signals 90 via the wireless communication unit 502 of the hardware layer 500. The processor 51 of the media player device 50 delivers the touch operation signals 90 between the software and hardware units of the media player device 50 in the sequence indicated by the path P2. The media player device 50 thus transmits the touch operation signals 90 to the target application 550 via a point function 521 in the system library 520. The target application 550 utilizes the touch operation signals 90 as the control signals to the object 72, or to a cursor, to perform a specific function.

Software and hardware units of the mobile device 40 include a hardware layer 400, an operating system kernel 410, a system library 420, a virtual system framework 430, and a remote control program 440. The system library 420 comprises a pointer function 421. The hardware layer 400 includes an touch device 401, a wireless communication unit 402, and other hardware components.

The operating system kernel 410 is Linux™ or other operating system kernel such as WINDOWS™, MAC OS™ or IOS™. The virtual system framework 430 may comprise an Android™ operating system or may comprise an instance of any other virtual machine. The wireless communication unit 402 is a wireless network device compatible with the Institute of Electrical and Electronics Engineers (IEEE) 802.11 standard or other wireless communication standard such as BLUETOOTH™ or ZIGBEE™.

The delivery and conversion of the touch operation signals 90 along the path P1 between the software and hardware units of the mobile device 40 (and then to the wireless network 60), as executed by the processor 41 of the mobile device 40, is shown in Table 1 as follows:

TABLE 1

| Sequence | Transmitting Unit | Receiving Unit |
|---|---|---|
| 1 | Touch device 401 | Operating System Kernel 410 |
| 2 | Operating System Kernel 410 | Pointer function 421 |
| 3 | Pointer function 421 | Virtual system framework 430 |
| 4 | Virtual system framework 430 | Remote Control Program 440 |
| 5 | Remote Control Program 440 | Virtual system framework 430 |
| 6 | Virtual system framework 430 | System Library 420 |
| 7 | System Library 420 | Operating System Kernel 410 |
| 8 | Operating System Kernel 410 | Wireless communication |
| | | unit 402 |
| 9 | Wireless communication | Wireless Network 60 |
| | unit 402 | |

Software and hardware units of the media player device 50 include a hardware layer 500, an operating system kernel 510, a system library 520, a virtual system framework 530, an input service 540, and a target application 550. The input service 540 is an application. The system library 520 comprises a pointer function 521. The operating system kernel 510 has an input control function 511. The hardware layer 500 further includes a wireless communication unit 502 and other hardware components of the media player device 50.

The operating system kernel 510 is LINUX™ or other operating system kernel such as WINDOWS™, MAC OS™ or IOS™. The virtual system framework 530 may comprise an ANDROID™ operating system or may comprise an instance of another virtual machine. The input control 511 may comprise a U input function of LINUX™ The wireless communication unit 502 and the wireless network 60 may respectively be a wireless network device and a wireless network compatible with the IEEE 802.11 standard or with another wireless communication standard such as BLUETOOTH™ or ZIGBEE™. The wireless network 60 may be one or more network devices which establish wireless network and communication channels. Alternatively, the network 60 may comprise a wide area network, such as one or more public land mobile networks (PLMNs) and Internet. The wireless communication units 402 and 502 may establish low latency wireless channel to transmit the touch operation signal 90. One example of the low latency wireless channel is a wireless channel utilizing a shortened transmission time interval (sTTI) adopted by a long term evolution (LTE) protocol.

The wireless communication unit 502 receives the touch operation signals 90 from the wireless network 60. The delivery and conversion of the touch operation signals 90 along the path P2 between the software and hardware units of the media player device 50, as executed by the processor 51 of the media player device 50, is shown in Table 2 as follows:

TABLE 2

| Sequence | Transmitting Unit | Receiving Unit |
|---|---|---|
| 1 | Wireless network 60 | Wireless communication |
| | | unit 502 |
| 2 | Wireless communication | Operating System Kernel 510 |
| | unit 502 | |
| 3 | Operating System Kernel 510 | System Library 520 |
| 4 | System Library 520 | Virtual system framework 530 |
| 5 | Virtual system framework 530 | Input service 540 |
| 6 | Input service 540 | Virtual system framework 530 |
| 7 | Virtual system framework 530 | System Library 520 |
| 8 | System Library 520 | Input control 511 |
| 9 | Input control 511 | Point function 521 |
| 10 | Point function 521 | Virtual system framework 530 |
| 11 | Virtual system framework 530 | Target Application 550 |

Touch operation signals received by the pointer function 421 are thus transferred and interpreted as touch operation signals dedicated to the pointer function 521, and are transferred to the target application 550 according to a connection or a relationship between the pointer function 521 and the target application 550. The connection or relationship may be based on function call or other control mechanism between the pointer function 521 and the target application 550. The target application 550 accordingly regards the touch operation signals 90 as user operation signals, such as pointer signals or others, to perform a function.

### 4. Touch Control and Gesture Recognition

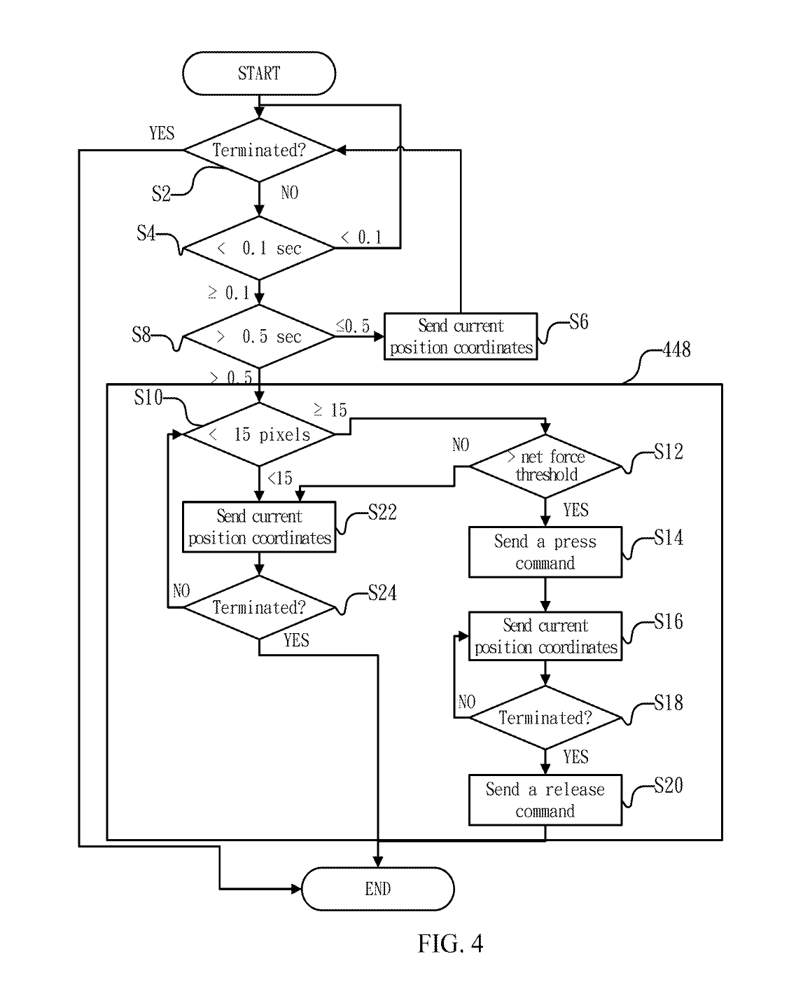

FIG. 4 shows a processing flow of the touch operation signals 90 by the mobile device 40 and the media player device 50. One or both of the processors 41 and 51 may execute the steps in FIG. 4. One or both of remote control application 440 and the input service 540 may process the touch operation signals 90 according to the steps in FIG. 4.

A determination as to whether a touch operation conveyed by the touch operation signals 90 has been terminated is executed (step S2). If the touch operation has been terminated, the process of FIG. 4 is ended. If the touch operation has not been terminated, a determination is made as to whether the touch operation has endured for at least 0.1 seconds (step S4). If the touch operation has not lasted for at least 0.1 seconds, step S2 is repeated. If the touch operation has continued for at least 0.1 seconds, a determination is made as to whether the touch operation has lasted for at least 0.5 seconds (step S8). If the touch operation has not lasted for at least 0.5 seconds, touch operation packets comprising current coordinates of the touch operation are continuously delivered (step S6). If the touch operation has last for at least 0.5 seconds, a determination is executed as to whether the touch operation has spanned or moved across at least 15 pixels (step S10). If the span of the touch operation has not exceeded 15 pixels, touch operation packets comprising current coordinates of the touch operation are continuously delivered (step S22), and another determination as to whether a touch operation has been terminated is executed (step S24). If the span of the touch operation has exceeded 15 pixels, a determination is executed as to whether a net force measurement of the touch operation exceeds the net force threshold (step S12). If the net force measurement of the touch operation does not exceed the net force threshold, step 22 is repeated. If the net force measurement of the touch operation does exceed the net force threshold, signals signifying a press-down event/operation or a long press event/operation are delivered (step S14), and touch operation packets comprising current coordinates of the touch operation continue to be delivered (step S16). A further determination as to whether the touch operation has been terminated is executed (step S18). If the touch operation has not been terminated, step S16 is repeated. If the touch operation has been terminated, a release signal representing release of the touch operation action is delivered (step S20).

One or both of the processors 41 and 51 generate a first instance of the press-down signal or a long press signal to initiate selection of the object 71 or 72.

One or both of the processors 41 and 51 performs the following steps for recognition of a dragging operation: a drag recognition unit 448 is utilized to determine whether the measurement of the net force of the touch operation signals 90 is sufficient to trigger a first dragging operation of the object 71 or 72. One or both of the processors 41 and 51 utilize the drag recognition unit 448 to determine whether the touch operation signals 90 comprise a span or movement exceeding n pixels, wherein the number n is an integer. If the span of the touch operation exceeds n pixels, the first dragging operation of the object 71 or 72 is thus triggered following the first selection operation and is later terminated in response to termination of the first selection operation.

In an alternative embodiment of the electronic system 10a, the processor 41 display a graphical user interface to receive a heavy press on the touch device 401 and generates the net force threshold according to the heavy press.

Touch operation signals for the heavy press, press-down, and a long press event/operation may be generated in series or in parallel, or in a selective way. When the touch operation signals are generated in series, for example, the electronic system 10a generates signals of a long press operation/event according to signals of a heavy press operation/event, and generates signals of a press-down operation/event according to signals of a long press operation/event. When the touch operation signals are generated in parallel, for example, the electronic system 10a generates signals of a long press operation/event and signals of a press-down operation/event in parallel according to signals of a heavy press operation/event. When the touch operation signals are generated in a selective way, for example, the electronic system 10a generates signals of a long press operation/event or of a press-down operation/event according to signals of a heavy press operation/event.

The remote control application 440 may generate signals of a long press operation/event or of a press-down operation/event based on the touch operation signals 90 and transmit the generated signals to the target application 550. Alternatively, the remote control application 440 may generate and transmit the touch operation signals 90 to the target application 550, and the target application 550 in turn generates signals of a long press operation/event or of a press-down operation/event based on the touch operation signals 90.

The touch control method coexists with the long press operation/event to provide additional options in controlling an object. The touch control method generates signals of a long press operation/event according to signals of a heavy press operation/event, which allows simulation of a long press operation/event by a heavy press operation/event. The generated long press operation/event may be utilized to trigger subsequent operations, such as generating a press-down operation/event for selecting an object. The touch control method thus reduces the time required to trigger selection of an object.

U.S. application Ser. No. 12/432,734, entitled “ELECTRONIC DEVICE SYSTEM UTILIZING A CHARACTER INPUT METHOD”, filed on Apr. 29, 2009, published as US20090273566A1, and issued as U.S. Pat. No. 8,300,016, which is based upon and claims the benefit of priority from Taiwan Patent Application No. 097116277, filed May 2, 2008 discloses a text input method. The entirety of the U.S. Pat. No. 8,300,016 is incorporated herein by reference. The text input method may utilize the touch control method to differentiate input operation of different input patterns on the same GUI element based on pressure or net force applied on the GUI element.

### 5. An Electronic Device Executing the Text Input Method

The text input method can be implemented in various electronic devices, such as cell phones, personal digital assistants (PDAs), set-top boxes (STB), televisions, or media players. An example of an electronic device implementing the character input method is given in the following.

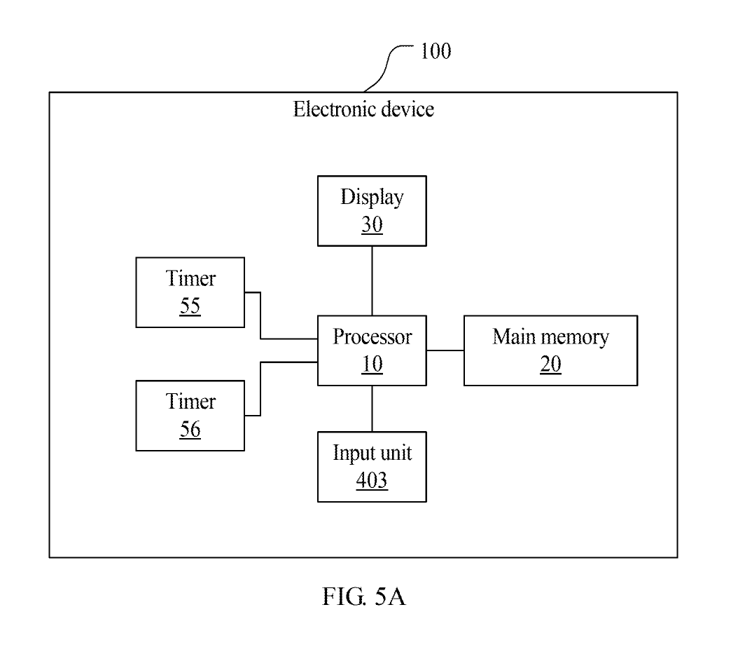

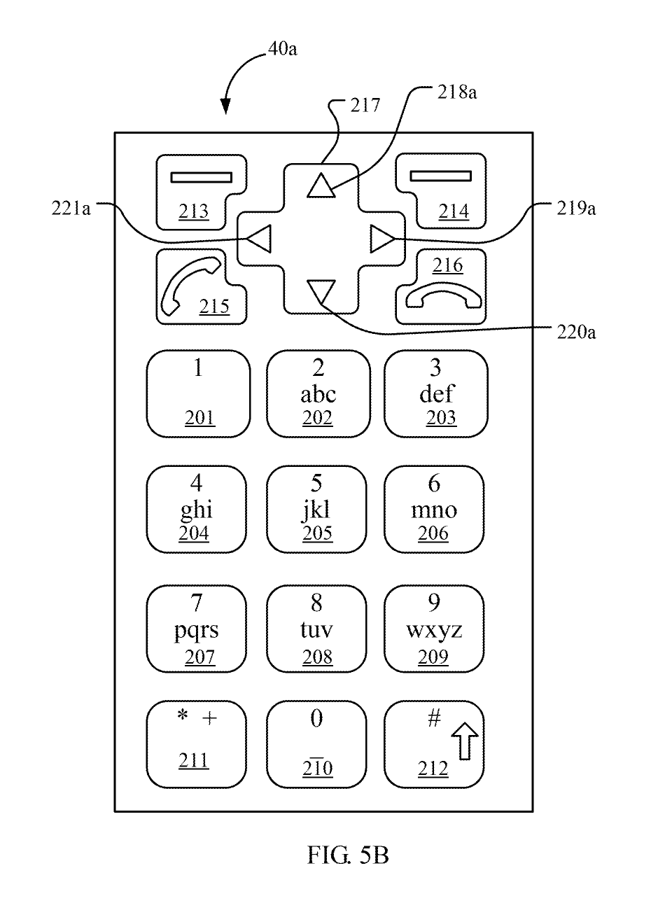

With reference to FIG. 5A, an electronic device 100 comprises a processor 10, a main memory 20, a display 30, an input unit 403, and timers 55 and 56. The electronic device 100 may be an embodiment of the device 40 or 50. The processor 10 may comprise various integrated circuits (ICs) for processing data and machine-readable instructions. The processor 10 may be packaged as a chip or comprise a plurality of interconnected chips. For example, the processor 10 may only comprise a central processing unit (CPU) or a combination of a CPU, a graphics processing unit (GPU), a digital signal processor (DSP), and a chip of a communication controller, such as communication units in FIG. 1A. The communication controller coordinates communication among components of the electronic device 100 or communication between the electronic device 100 and external devices. Examples of such communication controller, such as communication units in FIG. 1A, are detailed in the paragraphs of alternative embodiments. The device 100 may comprise a machine type communication device serving as a relay user equipment (UE) device as disclosed in U.S. patent application Ser. No. 14/919,016, published as US20160044651A1. The U.S. patent application Ser. No. 14/919,016 is herein incorporated by reference. The main memory 20 may comprise a random access memory (RAM), a nonvolatile memory, a mass storage device (such as a hard disk drive), or a combination thereof. The nonvolatile memory may comprise electrically erasable programmable read-only memory (EEPROM) and flash memory. The device 100 may comprise a electronic device as disclosed in U.S. patent application Ser. No. 14/558,728, published as US20150089105A1. The U.S. patent application Ser. No. 14/558,728 is herein incorporated by reference. The display 30 is configured for displaying text and image, and may comprise e-paper, a display made up of organic light emitting diode (OLED), or a liquid crystal display (LCD). The display 30 may display various graphical user interfaces including text area. The display 30 may comprise a single display or a plurality of displays in different sizes.

The input unit 403 may comprise various input devices to input data or signals to the electronic device 100, such as a touch panel, a touch screen, a keyboard, or a microphone. The device 100 may comprise a electronic device as disclosed in U.S. patent application Ser. No. 15/172,169, entitled “ VOICE COMMAND PROCESSING METHOD AND ELECTRONIC DEVICE UTILIZING THE SAME.” The U.S. patent application Ser. No. 15/172,169 is herein incorporated by reference. The input unit 403 may be a force sensitive device that provides pressure or force measurement in response to user operations. The timers 55 and 56 keeping predetermined time intervals may comprise circuits, machine-readable programs, or a combination thereof. Each of the timers 55 and 56 generates signals to notify expiration of the predetermined time intervals. Components of the device 100 can be connected through wire-lined or wireless communication channels.

A keyboard in FIG. 5B is an exemplary embodiment of the input unit 403. Note that the keyboard in FIG. 5B is not intended to limit the input unit 403. The input unit 403 may comprise a qwerty keyboard. The keyboard may be made of mechanical structures or comprise a virtual keyboard shown on the display 30. The keyboard comprises keys 201-217. Keys 213 and 214 are function keys for triggering functions based on software programs executed by the electronic device 100. A key 215 is an off-hook key, and a key 216 is an on-hook key. A key 217 is configured for directing direction and movement of a cursor on the display 30. Digits, letters, and/or symbols corresponding to the keys 201-212 are shown on respective keys in FIG. 5B, but are not intended to be limited thereto. Digits, characters, and/or symbols corresponding to and represented by a key may be referred to as candidates of the key. For example, the key 201 corresponds to digit “1,” the key 202 corresponds to digit “2” and characters “a”, “b”, and “c”, and the key 203 corresponds to digit “3” and characters “d”, “e”, and “f”. The key 210 corresponds to digit “0” and a space character; the key 212 corresponds to symbol “#” and a function for switching input methods. Different input methods differ in the ways of candidate character selection. As one of different input methods can be selectively activated, each key may accordingly correspond to different sets of characters. In an input method called “ABC input method”, one keystroke on the key 202 representing “A”, “B”, and “C” can be recognized as to present a character candidate “A”, two keystrokes to present “B”, and three keystroke to present “C”. In another input method called “abc input method”, one keystroke on the key 202 representing “a”, “b”, and “c” can be recognized as to present a character candidate “a”, two keystrokes to present “b”, and three keystroke to present “c”.

For example, the key 212 of the electronic device 100 may activate ABC input method, abc input method, or an autocomplete text input method. The electronic device 100 may be installed with a plurality of character input methods that are user-selectable. 3.

### Variation of Embodiments

With reference to FIG. 6B, a time interval t is utilized to identify first and second input patterns. More time intervals may be utilized to identify more input patterns. For example, a press operation on a key with duration less than a time interval t1 is identified as conforming to a first input pattern; a press operation on a key with a duration greater than the time interval t1 but less than a time interval t2 is identified as conforming to a second input pattern; and a press operation on a key with duration greater than the time interval t2 is identified as conforming to a third input pattern.

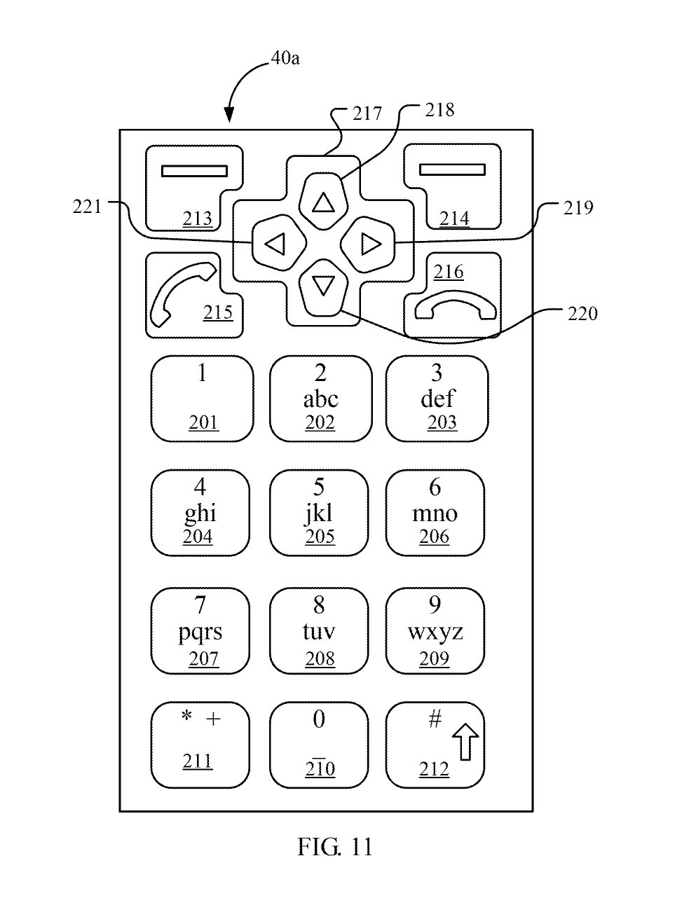

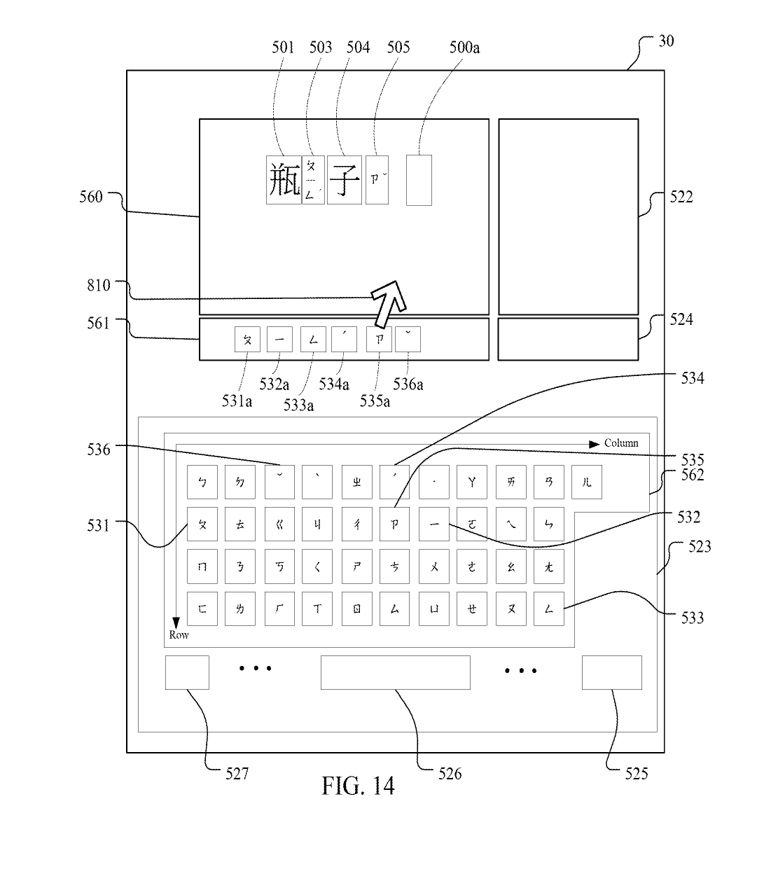

FIG. 6B shows a time line and signals generated from the key i during operation of the key. Key i may be a key in FIG. 5B, FIG. 11, or FIG. 14, and i is a variable.

Examples of input pattern recognition heuristic based on a threshold of time interval and a threshold of a force value for comparison with a detect force of the user operation are detailed in the following. and A high level in each signal waveform in FIG. 6B reflects a pressed state of the key i while a low level reflects a released state of the key i. Operation on the key i may generate different signal waveforms, not limited to FIG. 6B. The signal of a first operation shows that the key is pressed at time T0 and released at time T1. If (T1−T0)<t1, the processor 10 determines that the first operation conforms to the first input pattern. If t1≦(T2−T0)<t2, the processor 10 determines that the second operation conforms to the second input pattern. If t2≦(T3−T0), the processor 10 determines that the third operation conforms to the third input pattern. The processor 10 may activate a default sequence of key options for the key i in response to an operation conforming to the first input pattern, activate an alternative sequence, such as reversed sequence of key options, for the key i in response to an operation conforming to the second input pattern, and display a digit corresponding to the key i in response to an operation conforming to the third input pattern.

Although the input patterns are identified by time intervals, other parameters may be set as thresholds for identifying input patterns. For example, the input unit 403 may be a force sensitive device which provides force measurement of user operations on the input unit 403. Additional to the pressed and released states of a key, the input unit 403 may provide force related parameters to the processor 10. The processor 10 may determine a press on the input unit 403 as conforming to the first input pattern if the press provides a force value less than a force threshold, and determine a heavy press or a deep press on the input unit 403 as conforming to the second input pattern if the heavy press or the deep press provides a force value greater than the force threshold. Measurement of force related parameters is disclosed in U.S. patent application Ser. No. 14/941,678, entitled “TOUCH CONTROL METHOD AND ELECTRONIC SYSTEM UTILIZING THE SAME”, published as US20160070400.

### 5.1 Embodiments of Text Input Method

The processor 10 may display options, such as symbols, phonemes, character candidates or input method options, in a menu on the display 30 to assist character input.

Keys in the input unit 403 are classified as input method switching key, text keys and assistant keys. For example, the keys 201-212 are classified as text keys, and keys 213-217 are classified as assistant keys. The key 217 is a direction key and configured for triggering movement of a cursor to the upward, right, downward, and left when activated by a press at positions 218a, 219a, 220a, and 221a, respectively. The key 217 may receive a press in downward direction as a diversified operation in the fifth direction. The key 217 may be replaced by a five direction control means in another embodiment. Description of an alternative embodiment of an input method is given with reference to a keyboard in FIG. 2, FIG. 11, and FIG. 14.

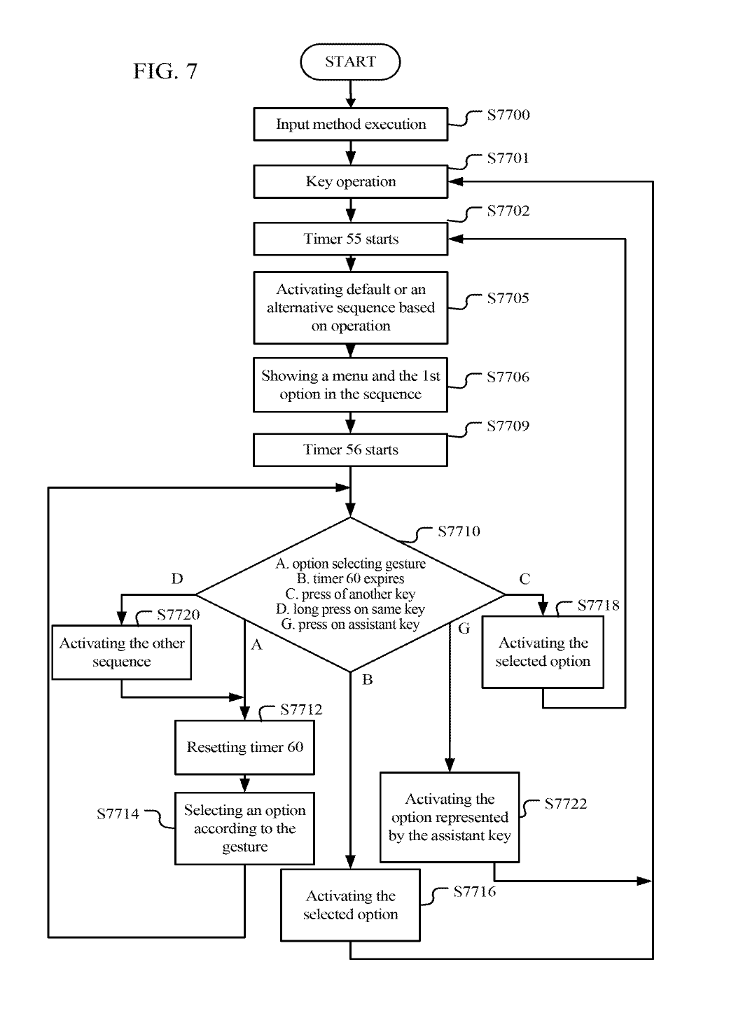

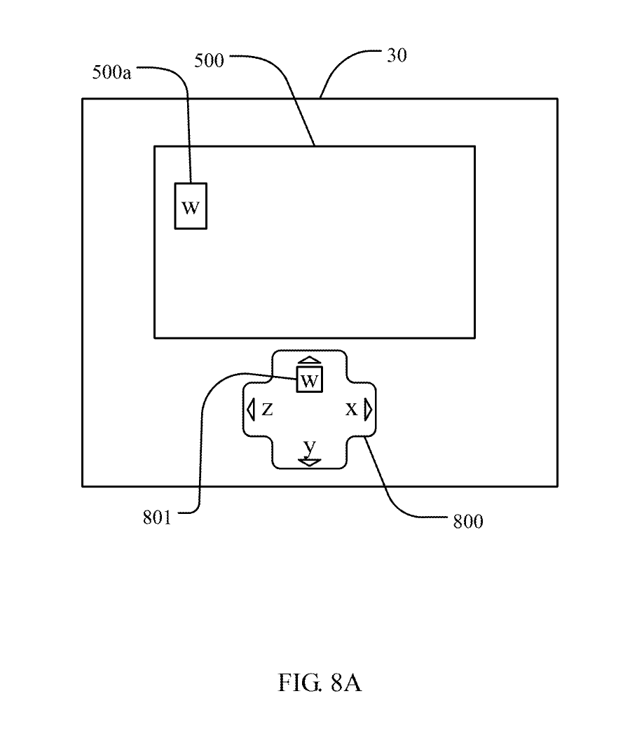

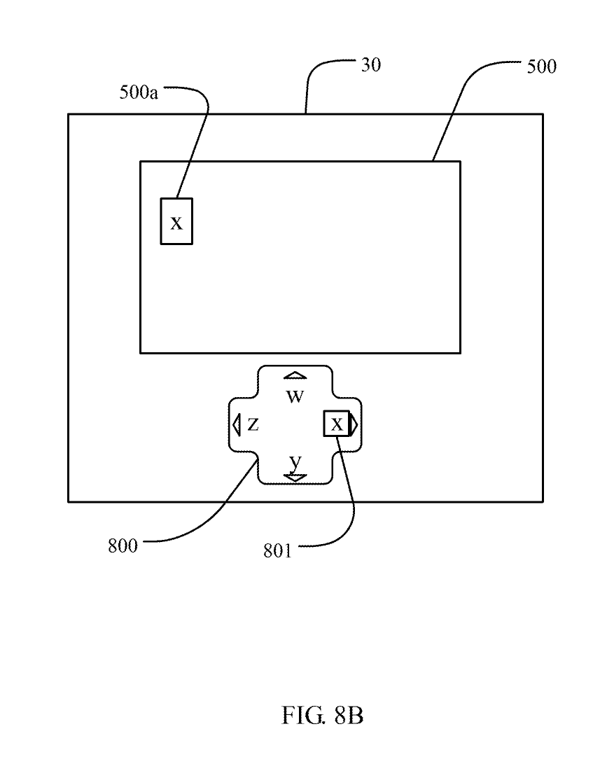

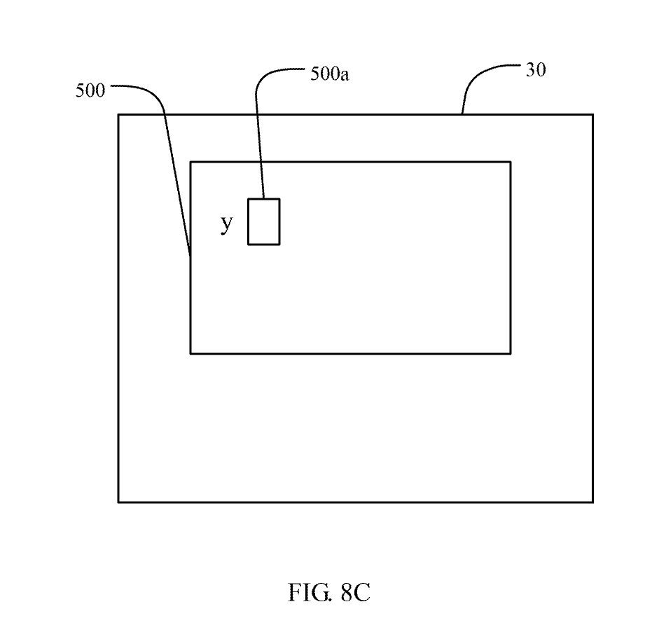

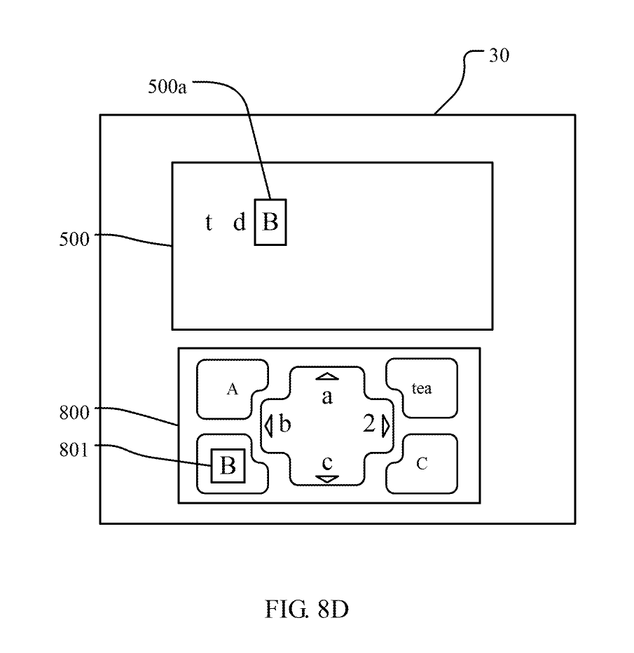

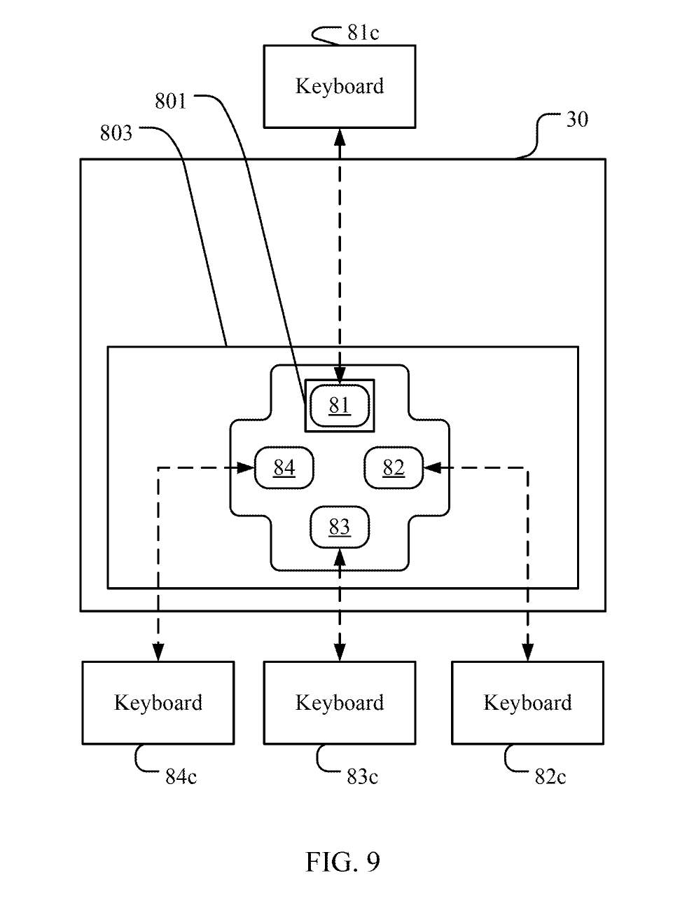

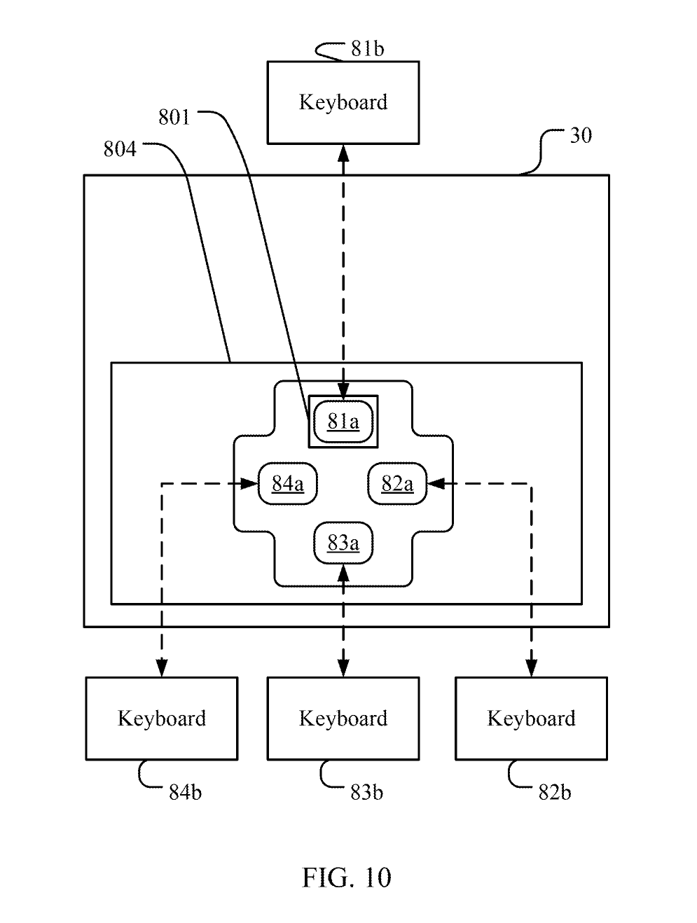

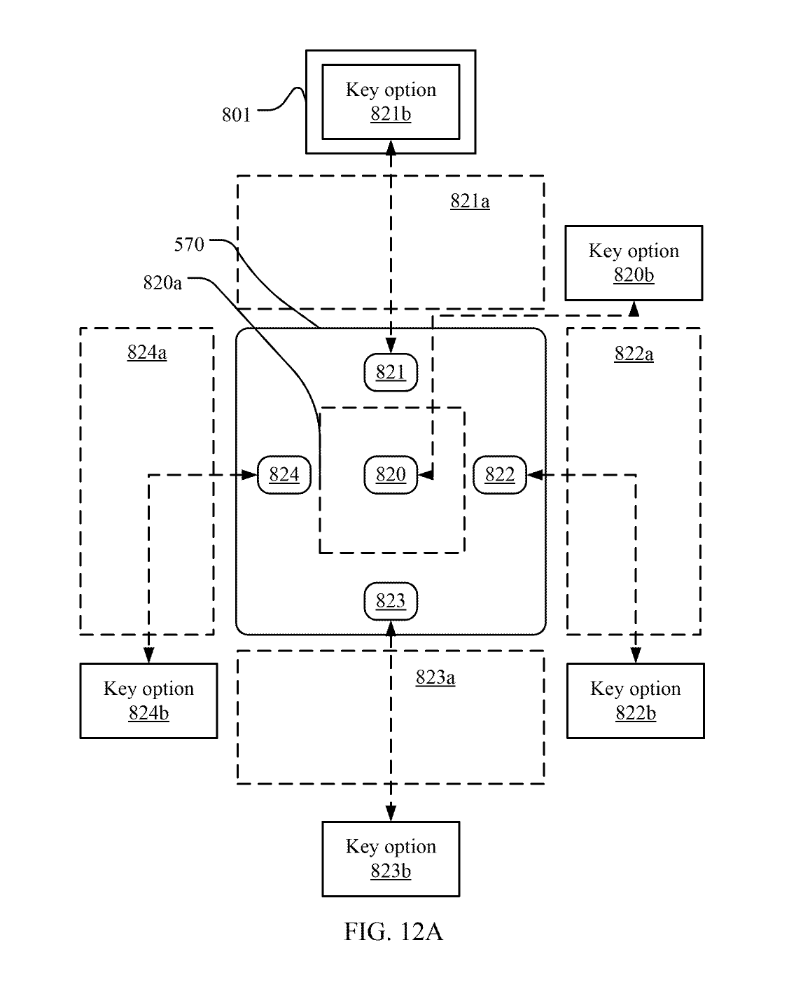

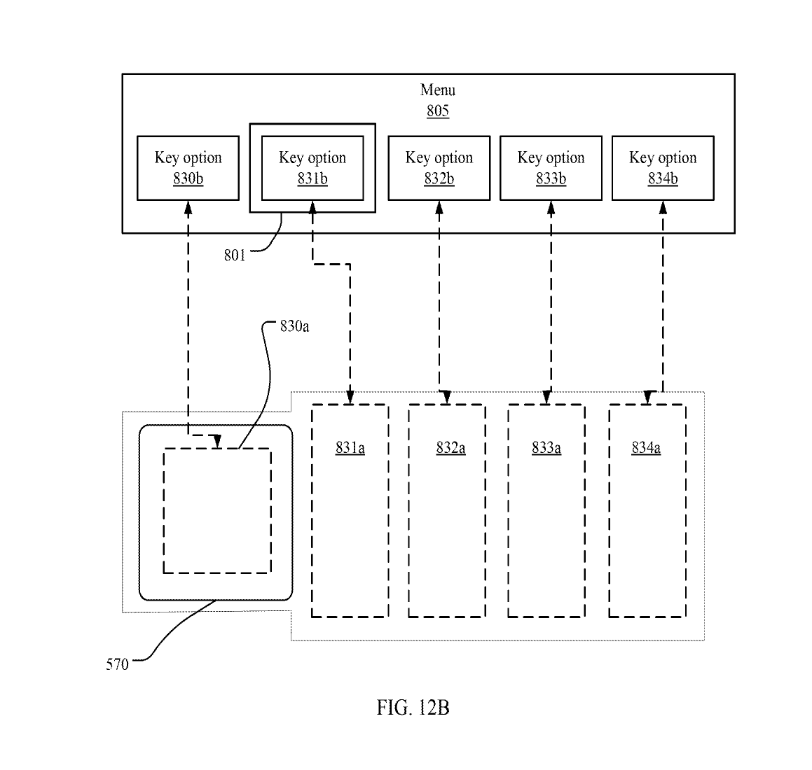

With reference to FIG. 7, the processor 10 initiates a character input method (step S7700) and determines if a key (referred to as the key i) in the input unit 403 is activated by a gesture operation (step S7701). Upon detecting that a gesture operation activates the key i, the processor 10 initiates the timer 55 to count the an operation period of the key i (step S7702) and activates one of the default sequence and an alternative sequence of the key i as the currently presented sequence based on whether the gesture operation conforms to the first input pattern or the second input pattern (step S7705). For example, the default sequence is activated as the currently presented sequence upon a condition that the gesture operation conforms to the first input pattern, and the alternative sequence is activated as the currently presented sequence upon a condition that the gesture operation conforms to the second input pattern. The alternative sequence, for example, may comprise the reversed sequence or an extended character set with additional character candidates and auto-competed word candidates. An example of the extended character set of the key 202 is shown in FIG. 8D. FIG. 9 and FIG. 10 respectively show a default sequence and an alternative sequence of key options of an input method switching key. FIG. 12A shows a default sequence of key options of a key 570 with symbols 820, 821, 822, 823, and 824. Each of the lines in FIG. 12A represents association between entities connected by the line. In the default sequence, the symbol 820 is associated with an operation area 820a which triggers activation of a key option 820b as the currently selected option when receiving an operation. The symbol 821 is associated with an operation area 821a, and the operation area 821a triggers activation of a key option 821b as the currently selected option when receiving an operation. The symbol 822 is associated with an operation area 822a, and the operation area 822a triggers activation of a key option 822b as the currently selected option when receiving an operation. The symbol 823 is associated with an operation area 823a, and the operation area 823a triggers activation of a key option 823b as the currently selected option when receiving an operation. The symbol 824 is associated with an operation area 824a, and the operation area 824a triggers activation of a key option 824b as the currently selected option when receiving an operation. At least one or more or each of the keys in FIGS. 2, 11, and 14 may be an embodiment of the key 570.

FIG. 12B shows an alternative sequence of key options of the key 570 with key options 830b, 831b, 832b, 833b, and 834b. Each of the lines in FIG. 12B represents association between entities connected by the line. In the alternative sequence, an operation area 830a triggers activation of a key option 830b as the currently selected option when receiving an operation. An operation area 831a triggers activation of a key option 831b as the currently selected option when receiving an operation. An operation area 832a triggers activation of a key option 832b as the currently selected option when receiving an operation. An operation area 833a triggers activation of a key option 833b as the currently selected option when receiving an operation. An operation area 834a triggers activation of a key option 834b as the currently selected option when receiving an operation. Each of the key options of in FIGS. 12A and 12B may comprises a function, a symbol, a phoneme, a character, an input method, a static icon, or an animated icon.

After the one of the default and alternative sequence is activated, the processor 10 displays a menu with a first option highlighted on the display 30 in the activated sequence (step S7706) and initiates the timer 56 to count an operation period of the key i (step S7709). For example, the processor 10 displays a menu on the display 30 with the first character candidate highlighted by a cursor or a focus in the activated sequence in the step S7706. The key activated in step S7701 may be an input method switching key, such as the key 212 in FIGS. 5B and 11, or key 527 in FIG. 14. If the key activated in step S7701 is an input method switching key, the processor 10 may display a menu 803 in FIG. 9 or a menu 804 in FIG. 10 in step S7706. The default sequence of input method options of the activated key may comprise input method options 81, 82, 83, and 84 which are associated with keyboard 81c, 82c, 83c, and 84c respectively. The alternative sequence of input method options of the activated key may comprise input method options 81a, 82a, 83a, and 84a which are associated with keyboard 81b, 82b, 83b, and 84b respectively. Each of the options 81, 82, 83, 84, 81a, 82a, 83a, and 84a may be selected and activated to activate the keyboard associated with the activated option. The association between the input method options and the keyboards are shown as dashed lines in FIGS. 9 and 10. The keyboards 81c, 82c, 83c, 84c, 81b, 82b, 83b, and 84b may comprise keyboards of different layouts, keyboards of different languages, and keyboards of input methods. For example, the at least some of the keyboards 81c, 82c, 83c, 84c, 81b, 82b, 83b, and 84b may comprise keyboards in FIGS. 5B, 11, and 14.

In an example that the key i is the key 209, a menu 800 corresponding to an activated default sequence of the key 209 is shown in 8A. Character candidates are arranged clockwise in the menu 800. Character candidates of a key, however, are not limited to FIG. 8A, and can be arranged counterclockwise or in any other arrangement. When the first character candidate “w” of the key 209 is shown in the text area 500, a cursor 801 indicates that “w” is a currently displayed character in the menu 800. The assistant keys 218, 219, 220, and 221 respectively correspond to character candidates “w”, “x”, “y”, and “z”. With reference to FIG. 9, if the key in step S7701 is an input method switching key and is activated by the gesture operation conforming to the first input pattern, the assistant keys 218, 219, 220, and 221 is respectively associated with input method options 81c, 82c, 83c, and 84c. With reference to FIG. 10, if the key in step S7701 is an input method switching key and is activated by the gesture operation conforming to the second input pattern, the assistant keys 218, 219, 220, and 221 is respectively associated with input method options 81b, 82b, 83b, and 84b.

The processor 10 detects occurrence of any subsequent option selecting gesture, such as short press on the same key i or a moving gesture or sliding gesture associated with the key i (event A), expiration of operation period of the key i signified by the timer 56 (event B), or any operation on another text key j (event C), or any long press on the key i (event D), or completion of the gesture operation on an assistant key or an operation area k (event G), where k is an positive integer. In the example of FIG. 11, the range of k is 213≦k≦221.

In the step S7710, upon receiving a option selecting gesture on the key i (event A), the processor 10 resets the timer 56 (step S7712) and selects an option in the sequence as a selected option (step S7714). For example, in a case that the key i comprises the key 209, following the arrangement in FIG. 8A, the processor 10 displays a next character candidate “x” in the default sequence “wxyz” as shown in FIG. 8B.

The cursor 801 in the menu 800 also moves clockwise to the position of “x” to indicate the currently displayed character. The step S7710 is repeated. Similarly, upon receiving a short press on the same key 209 (event A), the processor 10 resets the timer 56, and displays a next character candidate “y” in the default sequence “wxyz”. The cursor 801 in the menu 800 also moves clockwise to the position of “y” to indicate the currently displayed character.

Cursor 801 indicates an option as a selected option. The option selecting gesture may comprise a tap, a press, a swiping gesture, a moving gesture, or a sliding gesture which moves the cursor 801. A sliding gesture sequentially travels from key 218 to key 219, key 220, and key 221 in clockwise may trigger the cursor 801 to travels from w to x, y, and z in clockwise in response. A sliding gesture sequentially travels from key 221 to key 220, key 219, and key 218 in counterclockwise may trigger the cursor 801 to travels from z to y, x, and w in counterclockwise in response. In the example of FIG. 8D, A sliding gesture sequentially travels from key 218 to key 219, key 220, key 221, key 213, key 214, key 216, and key 215 in clockwise may trigger the cursor 801 to travels from a to 2, c, b, A, “tea”, C, and B in clockwise in response.

With reference to 9, a sliding gesture sequentially travels from key 218 to key 219, key 220, and key 221 in clockwise may trigger the cursor 801 to travels from input method options 81 to 82, 83, and 84 in clockwise in response. A sliding gesture sequentially travels from key 221 to key 220, key 219, and key 218 in counterclockwise may trigger the cursor 801 to travels from input method options 84 to 83, 82, and 81 in counterclockwise in response. With reference to 10, a sliding gesture sequentially travels from key 218 to key 219, key 220, and key 221 in clockwise may trigger the cursor 801 to travels from input method options 81a to 82a, 83a, and 84a in clockwise in response. A sliding gesture sequentially travels from key 221 to key 220, key 219, and key 218 in counterclockwise may trigger the cursor 801 to travels from input method options 84a to 83a, 82a, and 81a in counterclockwise in response.

In the step S7710, if the timer 56 expires (event B), the processor 10 activates a currently selected option of the key i, and updates GUI in display 30 (step S7716). For example, in the step S7716, the processor 10 enters a currently displayed character candidate of the key i to a text area, and moves the cursor to a next position in the text area. The step S7701 is repeated. For example, if “y” is the currently displayed character candidate when the timer 56 expires, as shown in FIG. 8C, the processor 10 enters “y” to the text area 500, moves the cursor 500a to a next position in the text area 500, and terminates presentation of the menu 800.

In the step S7710, upon receiving an operation on another text key j (event C), the processor 10 activates a currently selected option of the key i, updates GUI in display 30 (step S7718), and resets the timer 55 for the key j (step S7702). For example, in the step S7710, upon receiving an operation on another text key j (event C), the processor 10 enters a currently displayed character candidate of the key i to the text area, moves the cursor to a next position in the text area (step S7718), and resets the timer 55 for the key j (step S7702). The processor 10 repeats steps S7705, S7706, S7709, S7710, S7712, S7714, S7716, S7718, S7720, and S7722 following the step S7702 for the key j.

In the step S7710, upon receiving a long press on the same key i (event D), the processor 10 may activate an alternative sequence other than the currently presented sequence which is activated before the step S7720. For example, the processor 10 activate a sequence reverse to the currently presented sequence. For example, if the reversed sequence of the key i is utilized as the currently presented sequence in the step

S7710, the processor 10 activates the default sequence of the key i as the currently presented sequence. On the other hand, if the default sequence of the key i is utilized as the currently presented sequence in the step S7710, the processor 10 activates the reversed sequence of the key i as the currently presented sequence. Subsequently, in the step S7714, the processor 10 displays a next option in the activated sequence. In the example of FIG. 8A when the default sequence of the key 209 is activated as the currently presented sequence, upon receiving a long press on the same key 209 (event D), the processor 10 displays a character “z” previous to “w” in the default sequence “wxyz”, i.e. the character candidate next to “w” in the reversed sequence, and moves the cursor 801 clockwise to the position of “z” to indicate the currently displayed character.

The step S7710 is repeated. Similarly, upon receiving a subsequent long press on the same key 209 (event D), the processor 10 resets the timer 56, displays a character “y” next to “z” in the reversed sequence, and moves the cursor 801 clockwise to the position of “y” to indicate the currently displayed character. FIGS. 3C and 3D shows that a long press can change the currently presented sequence of character candidates. Route for traversing character candidates, however, can be controlled by various input devices, such as a dialer, a wheel, a rotatable knob, or a touch panel. The processor 10 may perform clockwise or counterclockwise movement of the cursor 801 and the currently displayed character in response to clockwise or counterclockwise tracks detected by the touch panel. The display 30 can be equipped with a touch panel to form a touch screen.

The keyboard in FIG. 11 can be a virtual keyboard displayed on the display 30. In the step S7710, upon completion of the gesture operation activating an assistant key k (event G), the processor 10 activates an option associated with the assistant key k and updates GUI (step S7722). For example, in the step S7710, upon receiving an operation on an assistant key k (event G), the processor 10 enter a character candidate corresponding to the key k to a text area, moves a cursor to a next position in the text area (step S7722), and repeats steps S7701, S7702, S7705, S7706, S7709, S7710, S7712, S7714, S7716, S7718, S7720, and S7722 following the step S7700. Following the example of FIG. 8A, in FIG. 8C, the processor 10 enters character “y” to the text area 500 in response to an operation on the key 220 disregarding the currently displayed. In the example of FIG. 8A, entering of character “y” to a text area requires two operations no matter in the default sequence or reversed sequence before expiration of the timer 56. With the aid of assistant keys, only one operation is required to enter the character “y” to a text area. Similarly, the processor enters character “w”, “x”, or “z” to the text area 500 in response to an operation on the key 218, 219, or 221. Character candidates of the key 209 can be input to electronic device 100 through the five schemes corresponding to events A, B, C, D, and G during execution of one input method with no confliction exist between these schemes.

In a condition that the key activated in step S7701 is an input method switching key, upon completion of the gesture operation activating an assistant key k (event G) in the step S7710, the processor 10 activates an input method option associated with the assistant key k and activates a keyboard associated with the activated input method option in step S7722. For example, with reference to FIG. 9, the processor 10 activates an input method option 83 associated with the assistant key 220 and activates the keyboard 813 associated with the activated input method option 83 in step S7722 in response to completion of the gesture operation activating the assistant key 220.

The menu 800 can include more candidates for a key, such as uppercase and lowercase letters, and auto-completed words. In addition to the direction key 217, voice commands or other keys can be utilized to represent character candidates in the menu 800.

### 5.2 Alternative Embodiments of the Text Input Method

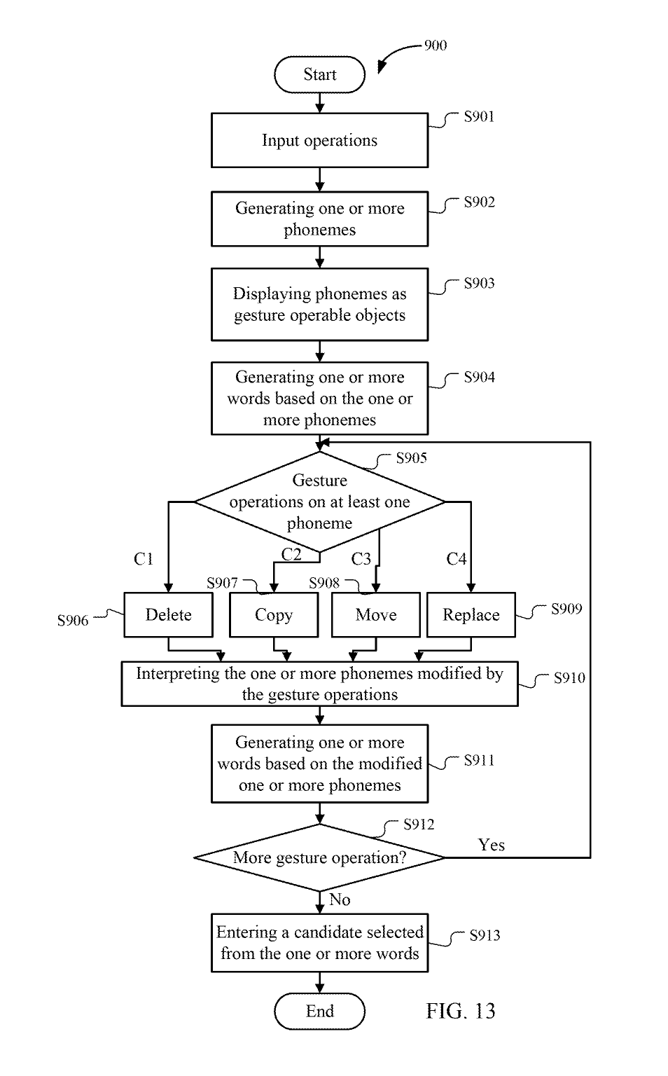

With reference to FIG. 13, the device 100 may further perform a gesture operation method associated with phonemes and character input. A phoneme is a constructing component of a word. For example, a phoneme may be a letter of English, a phonetic symbol of Chinese, a Hiragana or a Katakana symbol of Japanese. A processor, such as one of the processor 10, 41, and 51, executes a gesture operation method 900. The processor receives input operations from an input device (step S901), such as the input device 401, 403, or 501, and generates one or more phonemes in response to the received input operations (step S902). The processor displays each of the phonemes as a gesture operable object (step S903). A gesture operable object may be defined by a object-oriented programming language as a class with gesture operable features which can be inherited by an object created to contain an input phoneme. The processor may allow drag and drop of a gesture operable object, and force sensitive operations on a gesture operable object. The force sensitive operations is disclosed as an object selection operation in U.S. publication No. US20160070400. For example, with reference to FIG. 14, the processor displays a phoneme 531a as a gesture operable object in a phoneme area 561 in response to an operation on a key 531 in the first column and the second row of a text key array in area 562. A key in the m-th column and the n-th row of the text key array in area 562 may be denoted as key (m, n). The key 531 in the first column and the second row of the text key array in area 562 may be denoted as key (1, 2). Similarly, the processor displays phonemes 532a, 533a, 534a, 535a, and 536a as gesture operable objects in a phoneme display area 561 in response to operations on keys 532, 533, 534, 535 and 536 in area 562 of keyboard area 523. A key 527 may be an input method switching key. A key 526 may be a key for entering a space. A key 525 may be a enter key.

The processor may display words in word candidate area 524 based on the one or more phonemes (step S904). The words in word candidate area 524 comprises one or more words which can be derived from the input phonemes in phoneme area 561. For example, the processor displays word 501 derived from phonemes 531a, 532a, 533a, and 534a, and word 504 derived from phonemes 535a, and 536a. The processor also displays phonetic symbols 503 associated with the word 501 and the phonetic symbols 505 associated with the word 504 in area 560. The processor may alternatively not display the phonetic symbols 503 and 505.

The processor detects a gesture operation associated with at least one phoneme in the phoneme area 561 (step S905). The gesture operation may be applied to a single selected phoneme or a group of selected phonemes. One or more phonemes may be selected by a select operation or a select gesture. The phoneme related gesture operation applied on at least one phoneme may comprise a delete gesture (event C1), a copy gesture (event C2), a move gesture (event C3), and replace gesture (event C4). The processor modifies one or more phonemes in response to the delete gesture (step S906), copy gesture (step S907), move gesture (step S908), and replace gesture (step S909). The processor interprets the one or more phonemes modified by the gesture operations (step S910) and generates one or more words in a update list of words in area 524 based on the modified one or more phonemes (step S911).

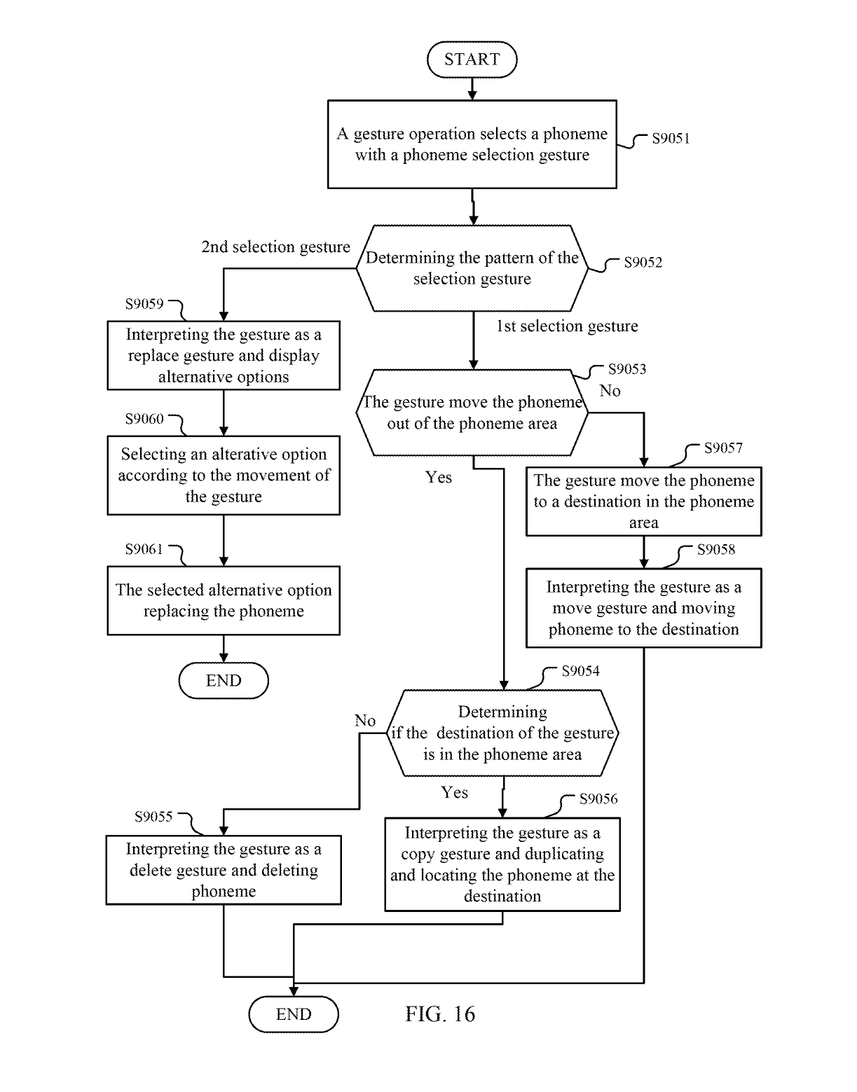

With reference to FIG. 16, examples of the steps S905-S912 are detailed in the following. Each of the phoneme related gesture, such as the delete, copy, move, and replace gesture, is initiated by selecting a phoneme or a set of one or more phonemes. The phoneme selecting is a select gesture which forms a first portion of a phoneme related gesture. The first portion of a gesture may be a press or a tap. A remaining portion of the gesture may be a swipe, a sliding, or a touch movement. The processor identifies the first portion of a phoneme related gesture, and determines whether the select gesture conforms to one of the input patterns. For example, each of the delete, copy, and move gesture comprises a select gesture which conforms to the first input pattern while the replace gesture comprises a select gesture which conforms to the second input pattern. The processor may differentiate the processing of the remaining portion of a phoneme related gesture according to the first portion of the phoneme related gesture.

If receiving a delete gesture associated with a phoneme (event C1) in the step S905, the processor deletes the phoneme associated with the delete gesture in response to the delete gesture. With reference to FIGS. 14 and 16, for example, a delete gesture 810 may comprise a select gesture which selects the phoneme 535a. The selection gesture 810 may comprise a press or tap gesture on the phoneme 535a or a gesture defining a rectangle enclosing the phoneme 535a. Upon receiving a phoneme related gesture on a phoneme (step S9051), the processor determines whether the select gesture forming the first portion of the phoneme related gesture conforms to the first input pattern or the second input pattern (step S9052). Upon a condition that the first portion of the phoneme related gesture conforms to the first input pattern, the processor further determines whether the gesture moves out of the phoneme area (step S9053). Upon a condition that the gesture moves out of the phoneme area, the processor further determines whether the gesture returns to the phoneme area and whether the destination of phoneme related gesture is in the phoneme area (step S9054). Upon a condition that the destination of phoneme related gesture is not in the phoneme area, the processor interprets the gesture as a delete gesture and deletes the selected phoneme (step S9055). Upon a condition that the destination of phoneme related gesture is in the phoneme area, the processor interprets the gesture as a copy gesture and places a duplicated copy of the selected phoneme at the destination (step S9056).

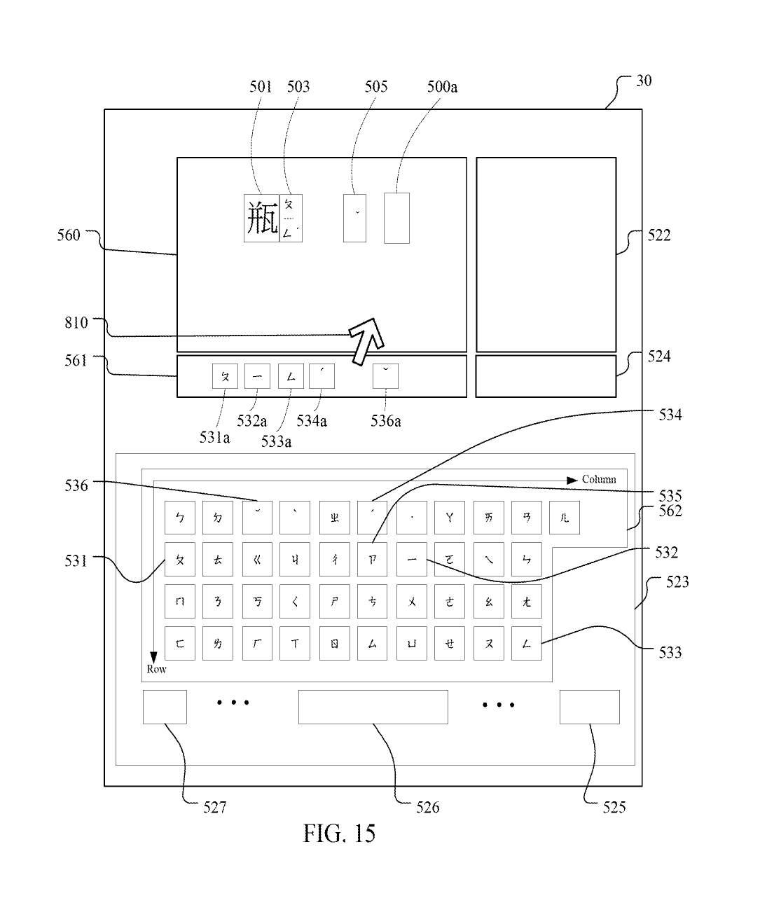

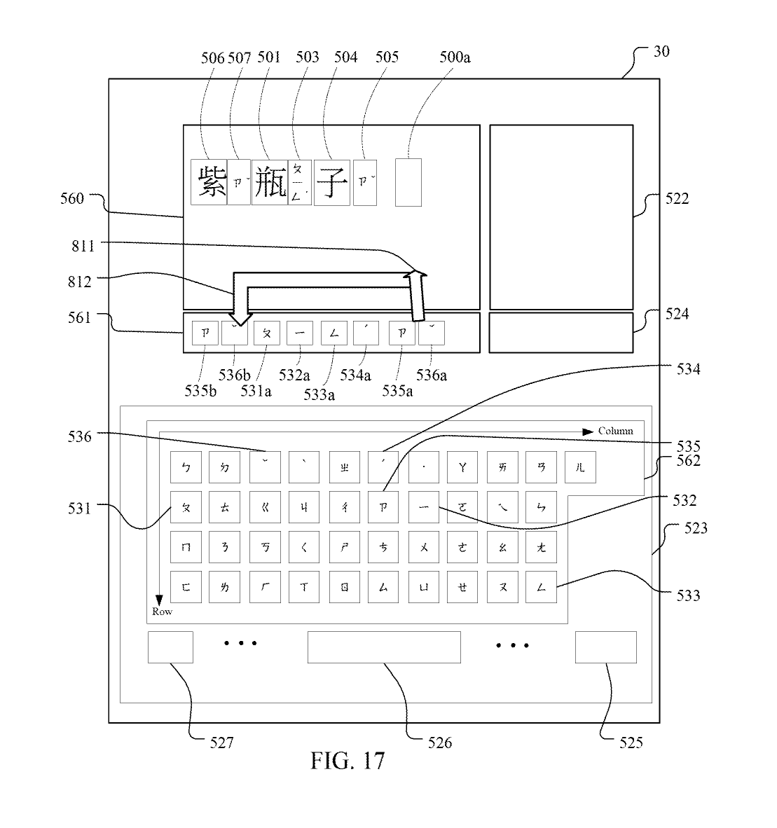

For example, upon detecting a drag and drop operation 810 carrying phoneme the 535a from an original location of the phoneme 535a in the area 561 to a destination out of the area 561, the processor interprets the drag and drop operation 810 as a delete gesture associated with the phoneme 535a. With reference to FIG. 15, the processor deletes the phoneme 535a in response to the delete gesture (step S906). If receiving a copy gesture associated with a phoneme (event C2) in the step S905, the processor duplicates the phoneme associated with the copy gesture, and places the duplicated phoneme at a destination associated with the copy gesture (step S907). With reference to FIG. 17, for example, a copy gesture may comprise a selection gesture which selects the phonemes 535a and 5356a. The selection gesture may comprise tap gesture on the phonemes 535a and 5356a or a gesture defining a rectangle enclosing the phonemes 535a and 5356a. The copy gesture comprises a drag and drop operation shown as segments 811 and 812. The segment 811 is a drag operation carrying the phonemes 535a and 5356a in the area 561 to a temporary location out of the area 561.

The segment 812 is a drag and drop operation carrying the phonemes 535a and 536a from the temporary location to a destination to the left of the phoneme 531a in the area 561. Upon detecting the drag and drop operation shown as segments 811 and 812, the processor interprets the drag and drop operation as a copy gesture associated with the phonemes 535a and 536a, and generates a copy of the phonemes 535a and 536a, shown as phonemes 535b and 536b, in response to the copy gesture (step S907). The word 506 is a word candidate which can be derived from the phonemes 535b and 536b. The phonetic symbols 507 is associated with the word 506.

In the step S9053 of FIG. 16, upon a condition that the phoneme related gesture moves within the phoneme area 561, the processor further determines the phoneme related gesture moves the selected phoneme to a destination (step S9057), interprets the gesture as a move gesture and move the selected phoneme to the destination (step S9058).

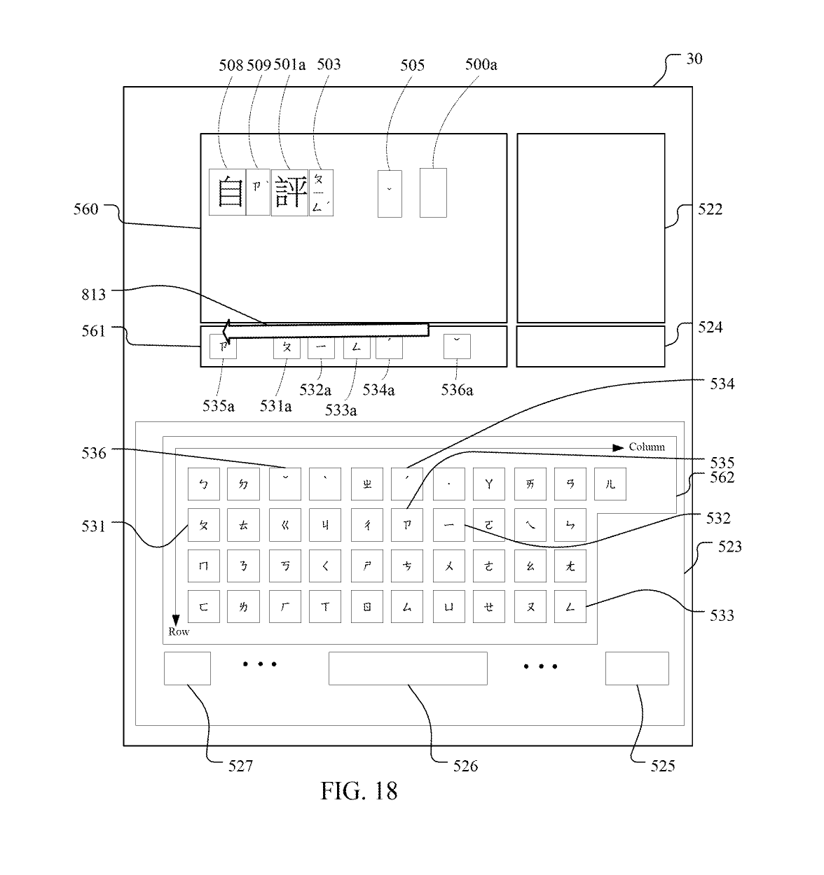

If receiving a move gesture associated with a phoneme (event C3) in the step S905, the processor moves the phoneme associated with the move gesture, to a destination associated with the copy gesture (step S908). With reference to FIG. 18, for example, a move gesture 813 may comprise a selection gesture which selects the phoneme 535a. The selection gesture 813 may comprise tap gesture on the phoneme 535a or a gesture defining a rectangle enclosing the phoneme 535a. The move gesture 813 comprises a drag and drop operation carrying the phoneme 535a along a path of the move gesture 813 within the area 561 to a destination. The destination of the move gesture 813 is located to the left of the phoneme 531a in the area 561. Upon detecting the drag and drop operation is complete with a destination in within the area 561, the processor interprets the drag and drop operation as a move gesture associated with the phoneme 535a and move the phoneme 535a to the destination in response to the move gesture (step S908). The word 504 disappears as the phoneme 535a has been moved to a new location. The word 508 is a word candidate which can be derived from the phoneme 535a. The phonetic symbols 509 is associated with the word 508. The word 501a is a word candidate which can be derived from the phonemes 531a, 532a, 533a, and 534a. The phonetic symbols 503 is associated with the word 501a. The words 508 and 501a form a phrase.

In the step S9052 of FIG. 16, upon a condition that the first portion of the phoneme related gesture conforms to the second input pattern, the processor interprets the gesture as a replace gesture and display a menu 522 of alternative options of the selected phoneme (step S9059). The processor selects an alternative option according to the movement of the remaining portion of the replace gesture (step S9060) and utilizes the selected alternative option to replace the phoneme selected in step S9051 (step S9061). The alternative options may comprise phonemes, symbols, emojies and other GUI elements.

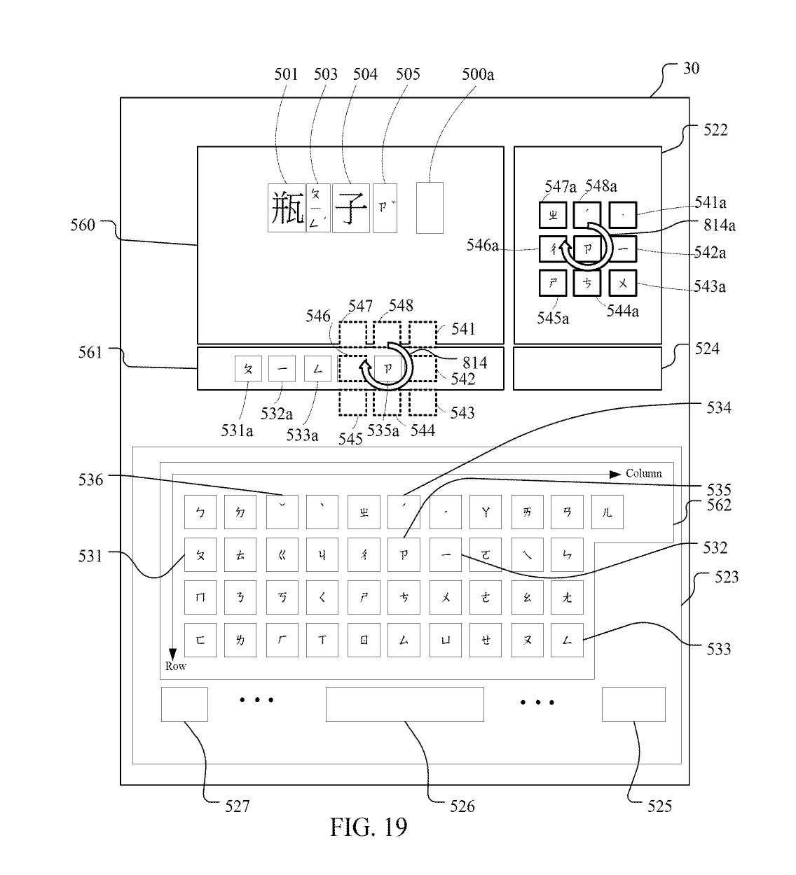

If receiving a replace gesture associated with an input phoneme (event C4) in the step S905, the processor selects an alternative phoneme in response to the replace gesture, and utilized the selected alternative phoneme to replace the input phoneme (step S909). With reference to FIG. 19, for example, a replace gesture 814 may comprise a selection gesture which selects the phoneme 535a. The selection gesture may comprise tap gesture on the phoneme 535a or a gesture defining a rectangle enclosing the phoneme 535a. The processor determines the selection gesture is associated with the replace gesture rather than the delete, copy, or move gesture, and interprets the movement of the replace gesture as commands for selecting an alterative phoneme. Upon detecting the replace gesture 814 associated with the phoneme 535a, the processor defines operation areas 541, 542, 543, 544, 545, 546, 547, and 548 relative to phoneme 535a. The operation areas 541, 542, 543, 544, 545, 546, 547, and 548 are respectively associated with alternative phonemes 541a, 542a, 543a, 544a, 545a, 546a, 547a, and 548a in alternative phoneme area 522. As the replace gesture 814 reaches one of the operation areas, a focus among the alternative phonemes moves to one of the alternative phonemes associated with the reached operation area. The path 814a in which the focus moves is synchronized with the gesture 814. For example, the alternative phoneme 541a is selected and is highlighted by the focus in response to the replace gesture 814 which moves to the operation area 541. Similarly, the alternative phoneme 542a is selected and is highlighted by the focus in response to the replace gesture 814 which moves to the operation area 542. Similarly, one of the alternative phonemes 543a-548a is selected and is highlighted by the focus in response to the replace gesture 814 which moves to associated one of the operation areas 543-548. Upon completion of the replace gesture 814 with one alternative phoneme being selected, the processor utilizes the selected alternative phoneme to replace the phoneme 535a. Similarly, other phonemes in the phoneme area 561 may replaced.

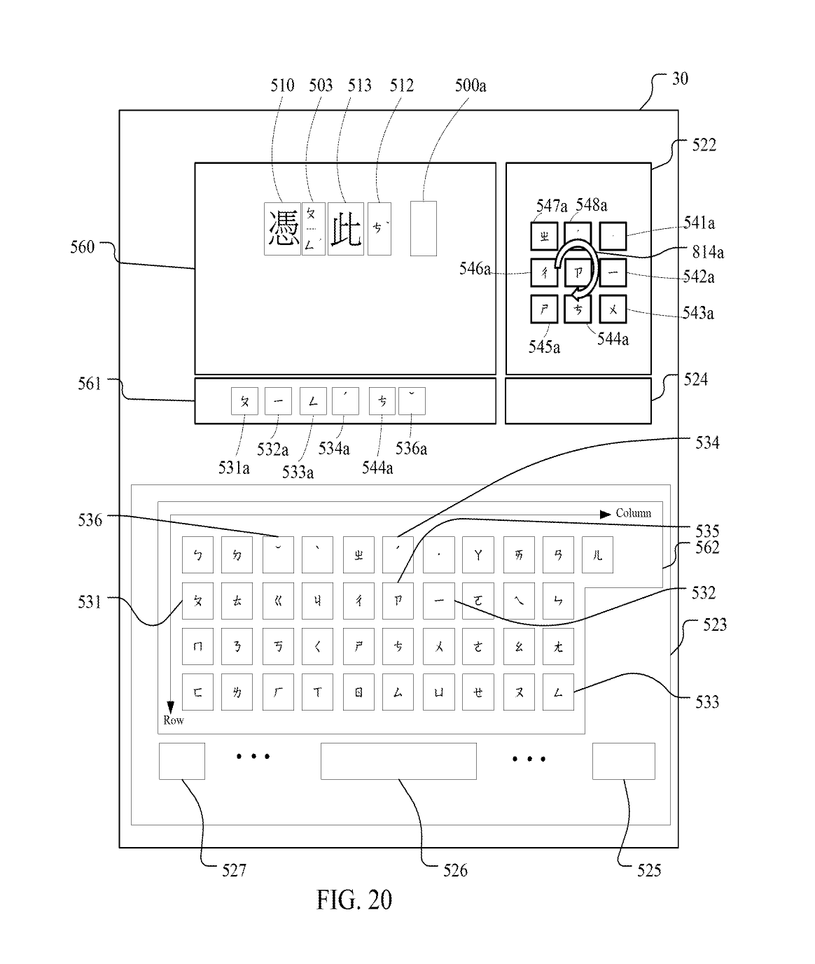

With reference to FIG. 20, the processor interprets the one or more phonemes modified by the replace gesture operations (step S910) and generates one or more words based on the modified one or more phonemes (step S911). The word 510 is a word candidate which can be derived from the phonemes 531a, 532a, 533a, and 534a. The phonetic symbols 503 is associated with the word 510. The word 513 is a word candidate which can be derived from the phonemes 544a, and 536a. The phonetic symbols 512 is associated with the word 513. The words 510 and 513 form a phrase.

The processor determines whether more gesture operations on at least one phoneme in the phoneme area 561 is detected (step S912). If detecting another gesture operation on at least one phoneme in the phoneme area 561, the processor process the gesture operation following the steps S905˜S911. If detecting a word candidate selection operation rather than an gesture operation, the processor inputs a word candidate into the text area 560 (step S913).

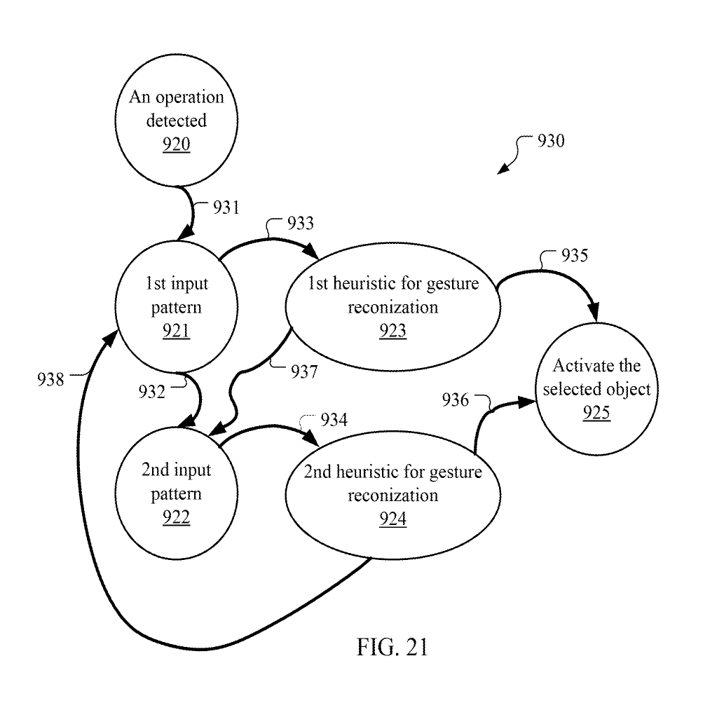

With reference to FIG. 21, the processor may process a gesture on an object, such as a GUI element, based on the state machine 930. Upon receiving a gesture on an object in state 920, such as a key, an input method switching GUI element, or a phoneme, the processor determines whether a first portion of the gesture conforms to the first input pattern. If the first portion of the gesture conforms to the first input pattern, the processor transits the object to state 921 through edge 931. In state 921, the processor determines whether a second portion of the gesture conforms to the second input pattern or triggers a first heuristic for recognition of the moving gesture. If the second portion of the gesture conforms to the second input pattern, the processor transits the object to state 922 through edge 932. In state 922, the processor determines whether a third portion of the gesture triggers a second heuristic for recognition of the moving gesture. In state 922, if the third portion of the gesture triggers a second heuristic for recognition of the moving gesture, the processor transits the object to state 924 through edge 934. In state 924, the processor utilizes the second heuristic to determine whether the gesture is completed by selecting an option of the object. The processor transits the object to state 925 to activate the option through edge 936 upon a condition that the gesture is completed by selecting the option of the object.

In state 921, if the second portion of the gesture triggers a first heuristic for recognition of the moving gesture, the processor transit the object to state 923 through edge 933. In state 923, the processor utilizes the first heuristic to determine whether the gesture is completed by selecting an option of the object. The processor transits the object to state 925 to activate the option through edge 935 upon a condition that the gesture is completed by selecting the option of the object. The state machine 930 further provides edge 937 allowing the object to transit from state 923 to state 922, and edge 938 allowing the object to transit from state 924 to state 921. In state 923, for example, the processor upon receiving a portion of the gesture on the object confirming to the second input pattern, transits the object from state 923 to state 922 through edge 937. In state 924, for example, the processor upon receiving a portion of the gesture on the object confirming to the first input pattern, transits the object from state 924 to state 921 through edge 938. The edge 937 may be a transition condition. The first heuristic comprises the transition condition to the second heuristic, the first heuristic handovers the work of subsequent processing of the remaining portion of the tap and move gesture to the second heuristic according to the transition condition. The edge 938 may be a return condition. The second heuristic comprises the return condition to the first heuristic, the second heuristic handovers the work of subsequent processing of the remaining portion of the tap and move gesture to the first heuristic according to the return condition. For example, the object in FIG. 21 may be a phoneme, and the first heuristic may comprise steps S906, S907, and S908, associated with GUI components in FIGS. 14, 15, 17, and 18. Similarly, the second heuristic may comprise step S909 associated with GUI components in FIGS. 19 and 20. Alternatively, the object in FIG. 21 may be a key, and the first heuristic may comprise steps S7706-S7722 and GUI components associated with the default sequence. Similarly, the second heuristic may comprise steps S7706-S7722 and GUI components associated with the alternative sequence.

### 6. Conclusion

The described embodiments of the text input method can be utilized to input characters of various languages, such as Hiragana and Katakana of Japanese, or phonetic symbols of Chinese. The character input method can be applied to keyboards with different layout. Other means such as highlighted color or size, rather than a cursor as described, can be utilized to indicate a currently display character candidate.

The touch control method coexists with the long press operation/event to provide additional options in controlling an object. The touch control method generates signals of a long press operation/event according to signals of a heavy press operation/event, which allows simulation of a long press operation/event by a heavy press operation/event. The generated long press operation/event may be utilized to trigger subsequent operations, such as generating a press-down operation/event for selecting an object. The touch control method thus reduces the time required to trigger selection of an object.

In conclusion, the text input method activates different sequences of key options in response to different operations on the same key and utilizes a menu to assist text input. The key options may comprise characters, phonemes, and input method schemes. The text input method may utilize the touch control method to differentiate the operations of different input patterns on the same key. The text input method reduces the number of operations and time required for character input, and thus eliminates the possibility of mis-operation.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A text input method executable by an electronic device, comprising:
allowing input of a set of one or more phonemes;
allowing each phoneme in the set of one or more phonemes to be gesture operable;
provide a list of word candidates derived from the set of one or more phonemes;
allowing modification of the set of one or more phonemes in response to a gesture on a phoneme in the set of one or more phonemes, thus to generate a modified set of one or more phonemes from the set of one or more phonemes;
providing a update list of word candidates derived from the modified set of one or more phonemes; and
allowing activation of options in the updated list of word candidates for text input.

2. The text input method as claimed in claim 1, wherein the gesture on the phoneme in the set of one or more phonemes comprises a tap and move gesture.

3. The text input method as claimed in claim 2, further comprising:
determining whether a first portion of the tap and move gesture conforms to a first input pattern or a second input pattern;
utilizing a first heuristic to process a remaining portion of the tap and move gesture upon a condition that the first portion of the tap and move gesture conforms to the first input pattern; and
utilizing a second heuristic to process the remaining portion of the tap and move gesture upon a condition that the first portion of the tap and move gesture conforms to the second input pattern.

4. The text input method as claimed in claim 3, further comprising:
utilizing the first heuristic to determining whether the remaining portion of the tap and move gesture conforms to a delete gesture; and
deleting the phoneme from the set of one or more phonemes to generate the modified set of one or more phonemes upon a condition that the remaining portion of the tap and move gesture conforms to the delete gesture.

5. The text input method as claimed in claim 4, further comprising:
the remaining portion of the tap and move gesture conforms to the delete gesture if the remaining portion of the tap and move gesture carries the phoneme out of a phoneme area in which the set of one or more phonemes is located.

6. The text input method as claimed in claim 3, further comprising:
utilizing the first heuristic to determining whether the remaining portion of the tap and move gesture conforms to a copy gesture; and
generating a copy of the phoneme and adding the copy of the phoneme to the set of one or more phoneme to generate the modified set of one or more phonemes upon a condition that the remaining portion of the tap and move gesture conforms to the copy gesture.

7. The text input method as claimed in claim 6, further comprising:
the remaining portion of the tap and move gesture conforms to the copy gesture if the remaining portion of the tap and move gesture carries the phoneme out of a phoneme area in which the set of one or more phonemes is located, and carries the phoneme back to a destination in the phoneme area.

8. The text input method as claimed in claim 3, further comprising:
utilizing the first heuristic to determining whether the remaining portion of the tap and move gesture conforms to a move gesture; and
moving the phoneme to a target location to generate the modified set of one or more phonemes upon a condition that the remaining portion of the tap and move gesture conforms to the move gesture.

9. The text input method as claimed in claim 8, further comprising:
the remaining portion of the tap and move gesture conforms to the move gesture if the remaining portion of the tap and move gesture carries the phoneme to the target location in a phoneme area in which the set of one or more phonemes is located, and the path of the remaining portion of the tap and move gesture is within the phoneme area.

10. The text input method as claimed in claim 3, further comprising:
utilizing the second heuristic to determining whether the remaining portion of the tap and move gesture conforms to a replace gesture; and
utilizing an alternative symbol to replace the phoneme to generate the modified set of one or more phonemes upon a condition that the remaining portion of the tap and move gesture conforms to the replace gesture.

11. The text input method as claimed in claim 10, further comprising:
the remaining portion of the tap and move gesture conforms to the replace gesture if the remaining portion of the tap and move gesture triggers selection of the alternative symbol according to the movement of the remaining portion of the tap and move gesture.

12. The text input method as claimed in claim 3, further comprising:
determining that the first portion of the tap and move gesture conforms to the first input pattern upon a condition that an operation period of the first portion of the tap and move gesture is less than a time threshold; and
determining that the first portion of the tap and move gesture conforms to the second input pattern upon a condition that the operation period of the first portion of the tap and move gesture is greater than the time threshold.

13. The text input method as claimed in claim 3, further comprising:
determining that the first portion of the tap and move gesture conforms to the first input pattern upon a condition that force measurement associated with the first portion of the tap and move gesture is less than a force threshold; and
determining that the first portion of the tap and move gesture conforms to the second input pattern upon a condition that the force measurement associated with the first portion of the tap and move gesture is greater than the force threshold.

14. The text input method as claimed in claim 3, wherein the first heuristic comprises a transition condition to the second heuristic, the first heuristic handovers processing of the remaining portion of the tap and move gesture to the second heuristic according to the transition condition.

15. The text input method as claimed in claim 3, wherein the second heuristic comprises a return condition to the first heuristic, the second heuristic handovers processing of the remaining portion of the tap and move gesture to the first heuristic according to the return condition.

16. A text input method executable by an electronic device, comprising:
detecting a gesture operation on an graphical user interface object associated with a text input function;
utilizing an input pattern recognition heuristic to determine whether a first portion of the gesture operation conforms to one of a first input pattern and a second input pattern;
utilizing a first gesture recognition heuristic to process a second portion of the gesture operation upon a condition that first portion of the gesture operation conforms to the first input pattern, wherein the first gesture recognition heuristic is utilized to determine whether the second portion of the gesture operation triggers an option in a first set of options associated with the graphical user interface object; and
utilizing a second gesture recognition heuristic to process a subsequent portion of the gesture operation upon a condition that first portion of the gesture operation conforms to the second input pattern, wherein the second gesture recognition heuristic is utilized to determine whether the subsequent portion of the gesture operation triggers an option in a second set of options associated with the graphical user interface object.

17. The text input method as claimed in claim 16, wherein the input pattern recognition heuristic is utilized to determine whether the first portion of the gesture operation conforms to one of the first input pattern and the second input pattern according to a threshold of time interval.

18. The text input method as claimed in claim 16, wherein the input pattern recognition heuristic is utilized to determine whether the first portion of the gesture operation conforms to one of the first input pattern and the second input pattern according to a threshold of a force value for comparison with a detected force value of the gesture operation.
